(19) United States
(12) Patent Application Publication
(10) Pub. No.: US 2025/0389571 A1
(43) Pub. Date: Dec. 25, 2025

(54) APPARATUS AND METHOD FOR FLUID COMPOSITION ANALYSIS

(71) Applicant: MOHAMMADREZA MAJIDPOUR, TEHRAN (IR)

(72) Inventor: MOHAMMADREZA MAJIDPOUR, TEHRAN (IR)

(21) Appl. No.: 19/213,780

(22) Filed: May 20, 2025

Related U.S. Application Data
(63) Continuation-in-part of application No. PCT/IB2023/056314, filed on Jun. 19, 2023.

(30) Foreign Application Priority Data
Nov. 20, 2022 (IR) 14015014000300610

(51) Int. Cl. G01F 23/263; B01D 17/12; C10G 33/02; G01F 1/56; G01F 1/76

(52) U.S. Cl. CPC G01F 23/268; B01D 17/12; C10G 33/02; G01F 1/56; G01F 1/76

(57) ABSTRACT

In accordance with some embodiments herein, an apparatus is provided. The apparatus includes a conduit, a first electrode, a second electrode, a power source, a valve, and a controller. The conduit is configured to conduct a mixture along a flow path. The first electrode is placed proximal the flow path defined by the conduit. The second electrode is placed proximal the flow path defined by the conduit. The power source is configured to apply a voltage across the first electrode and the second electrode. The valve is coupled to the conduit and configured to control flow of the mixture through the flow path defined by the conduit. The controller is configured to determine a first capacitance of a first capacitor established by the first electrode, the second electrode, and the mixture flowing along the flow path. The controller controls the valve based upon the first capacitance.

### RELATED APPLICATIONS

This application claims priority to and is a continuation-in-part of International Application Number PCT/IB2023/056314, filed on Jun. 19, 2023, entitled “AUTOMATIC SYSTEM FOR DISCHARGE OF WATER AND SLUDGE FROM THE BOTTOM OF HYDROCARBON STORAGE TANKS”, which claims priority to Iran Application Number 140150140003006100, filed on Nov. 20, 2022. International Application Number PCT/IB2023/056314 and Iran Application Number 140150140003006100 are incorporated herein by reference in their entirety.

### TECHNICAL FIELD

The present invention relates generally to fluid analysis systems, and more particularly to apparatuses and methods for evaluating a composition and flow rate of a fluid mixture using capacitive sensing techniques within a flow conduit.

### BACKGROUND

In various industrial, chemical, and biomedical applications, accurate real-time analysis of fluid mixtures is essential for process control, quality assurance, and safety. In petroleum industry, crude oil extracted from production often contains significant amounts of water and/or sludge, which must be separated and removed to meet quality standards and avoid downstream processing issues. One common stage where water separation occurs is in storage tanks, where gravity settling allows water to accumulate at the bottom of the storage tanks due to its higher density. Traditionally, the removal of water from crude oil tanks has been performed manually, relying on operator judgment to periodically open drain valves. This manual approach is labor-intensive, prone to error, and can result in either excessive oil loss or incomplete water removal. To improve efficiency and automation, sensor-based techniques have been introduced to detect concentration of water and oil, enabling more precise drainage control. However, many of these existing technologies utilize sensors that come into direct contact with crude oil mixture. Over time, exposure to chemically aggressive and viscous nature of crude oil, as well as contaminants such as sediments and emulsions, may degrade sensor materials, reduce measurement accuracy, and lead to frequent maintenance or replacement. Accordingly, there is a need for a more reliable, non-intrusive sensing solution capable of determining fluid composition within the crude oil tanks. The present invention addresses this need by providing a capacitive sensing system in which electrodes are positioned proximal, but not in direct contact with, a fluid mixture. This configuration enables accurate composition analysis while reducing sensor damage and extending operational lifespan.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In some embodiments, an apparatus is provided. The apparatus includes a conduit, a first electrode, a second electrode, a power source, a valve, and a controller. The conduit is configured to conduct a mixture along a flow path. The first electrode is placed proximal the flow path defined by the conduit. The second electrode is placed proximal the flow path defined by the conduit. The power source is configured to apply a voltage across the first electrode and the second electrode. The valve is coupled to the conduit and configured to control flow of the mixture through the flow path defined by the conduit. The controller is configured to determine a first capacitance of a first capacitor established by the first electrode, the second electrode, and the mixture flowing along the flow path. The controller controls the valve based upon the first capacitance.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates an exploded view of an apparatus showing individual components and relative positions of the individual components prior to assembly, in accordance with some embodiments.

FIG. 1B illustrates a perspective view, a side view and a cross-sectional view of a flange of an apparatus, in accordance with some embodiments.

FIG. 1C illustrates a perspective view, a side view and a cross-sectional view of a non-conductive pipe of an apparatus, in accordance with some embodiments.

FIG. 1D illustrates a perspective view, a side view and a cross-sectional view of a conductive pipe of an apparatus, in accordance with some embodiments.

FIG. 1E illustrates a perspective view of a protective enclosure of an apparatus, in accordance with some embodiments.

FIG. 1F illustrates a perspective view of an apparatus, in accordance with some embodiments.

FIG. 1G illustrates a cross-sectional view of an apparatus, in accordance with some embodiments.

FIG. 1H illustrates a top view of a first electrode and a second electrode in unfolded configurations, prior to being placed on outer surface of a non-conductive pipe, in accordance with some embodiments.

FIGS. 2A-2B illustrate a schematic view of a system incorporating an apparatus, wherein the apparatus is configured to actuate a valve based upon detecting one or more composition properties of a first mixture, in accordance with some embodiments.

FIGS. 2C-2E illustrate movement of a first mixture within a non-conductive pipe 104 associated with an apparatus, in accordance with some embodiments.

FIG. 2F illustrates a table presenting varying concentration of a first substance and a second substance in a first mixture and corresponding capacitances measured by an apparatus, in accordance with some embodiments.

FIGS. 3A-3C illustrate various stages of charging and/or discharging a first capacitor of an apparatus using a mixture evaluation device, in accordance with some embodiments.

FIGS. 4A-4B illustrate two stages of measuring flow rate of a first mixture using an apparatus, in accordance with some embodiments.

FIG. 5 illustrates an image of a plurality of shapes associated with capacitor electrodes designed for placement on a plurality of non-conductive pipes with different geometries, in accordance with some embodiments.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative.

The present disclosure provides an apparatus. In some examples, the apparatus may comprise a conduit, a first electrode, a second electrode, a power source, a valve, and a controller. In some examples, the conduit may conduct a mixture along a flow path. In some examples, the first electrode may be placed proximal the flow path defined by the conduit. In some examples, the second electrode may be placed proximal the flow path defined by the conduit. In some examples, the power source may apply a voltage across the first electrode and the second electrode. In some examples, the valve may be coupled to the conduit and may control flow of the mixture through the flow path defined by the conduit. In some examples, the controller may determine a first capacitance of a first capacitor established by the first electrode, the second electrode, and the mixture flowing along the flow path. In some examples, the controller may control the valve based upon the first capacitance. Alternatively and/or additionally, the apparatus may comprise a third electrode, and a fourth electrode. The third electrode may be placed proximal the flow path defined by the conduit. The fourth electrode may be placed proximal the flow path defined by the conduit. Alternatively and/or additionally, the power source may be configured to apply a second voltage across the third electrode and the fourth electrode. Alternatively and/or additionally, the controller may comprise a mixture evaluation device. In some examples, the mixture evaluation device may be configured to determine a first set of capacitances of a first capacitor established by the first electrode, the second electrode, and the mixture flowing along the flow path, wherein the first set of capacitances comprises one or more capacitances of the first capacitor at one or more first times. Alternatively and/or additionally, the mixture evaluation device may be configured to determine a second set of capacitances of a second capacitor established by the third electrode, the fourth electrode, and the mixture flowing along the flow path, wherein the second set of capacitances comprises one or more capacitances of the second capacitor at one or more second times. In some examples, the mixture evaluation device may determine a flow rate of the mixture flowing through the flow path based upon the first set of capacitances and the second set of capacitances.

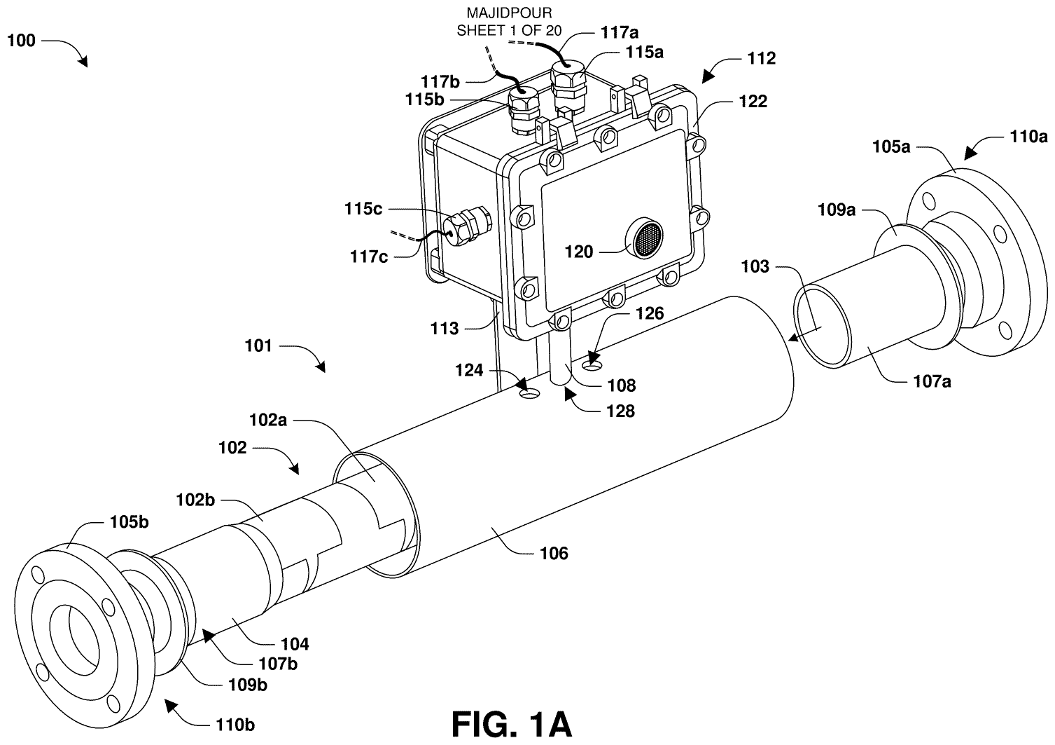

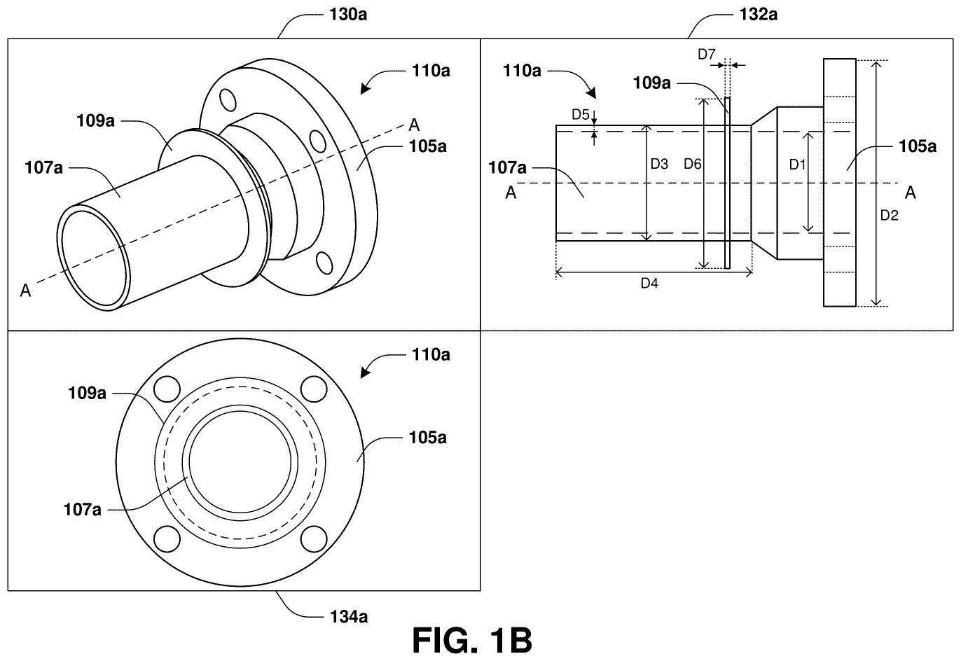

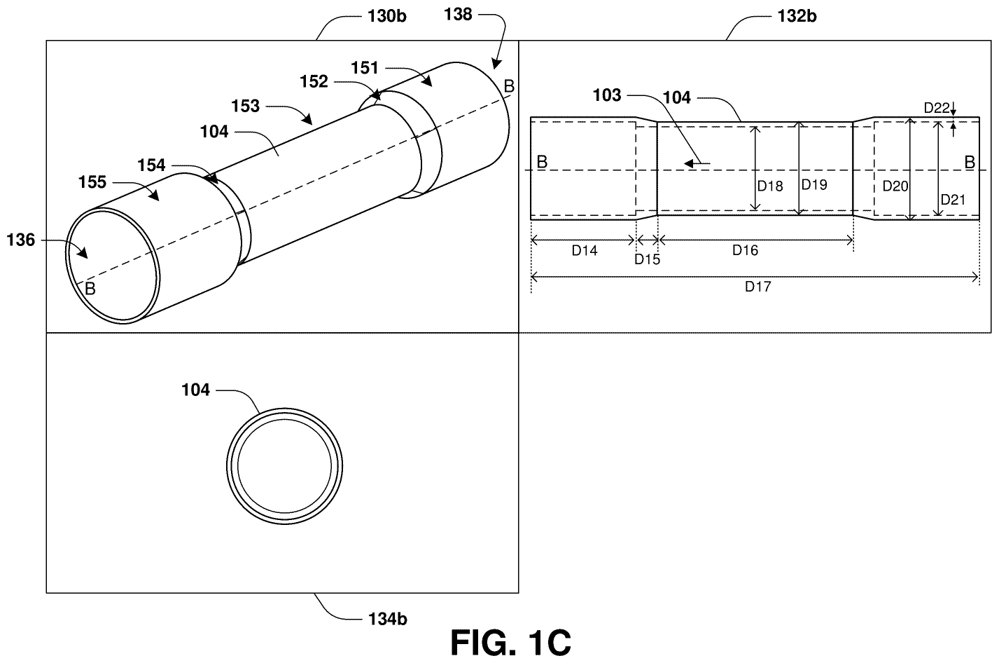

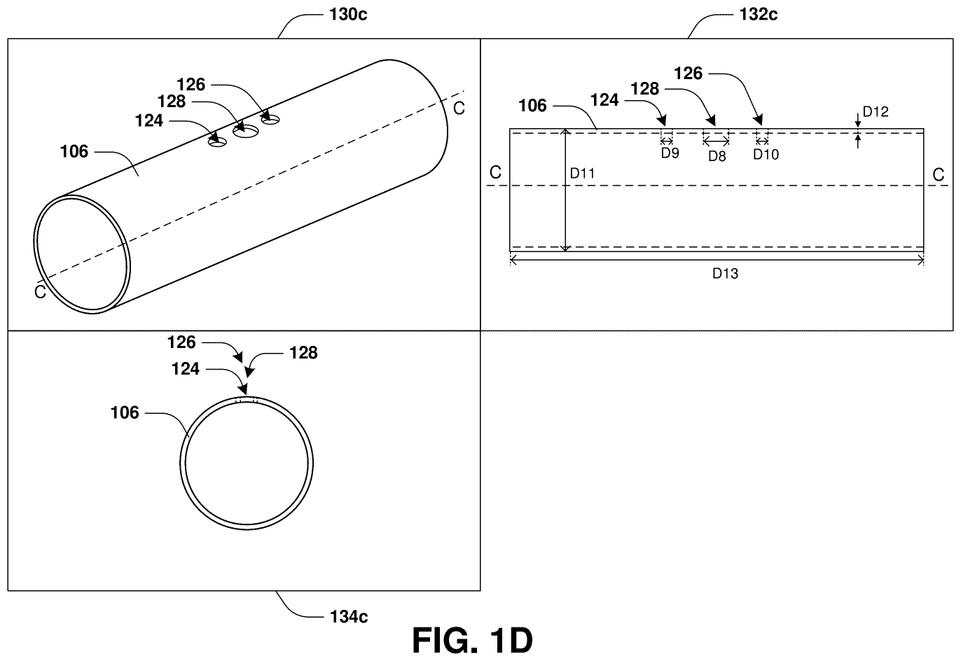

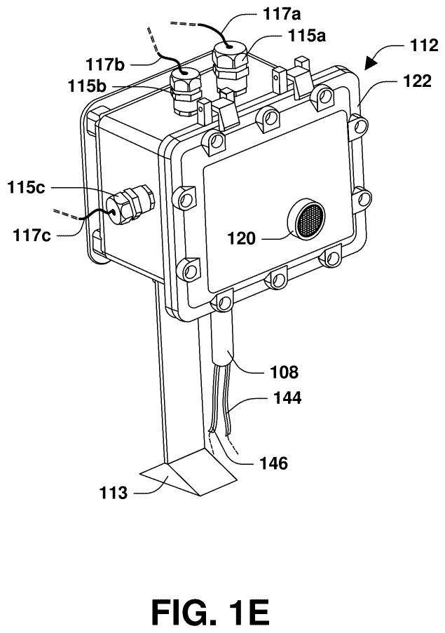

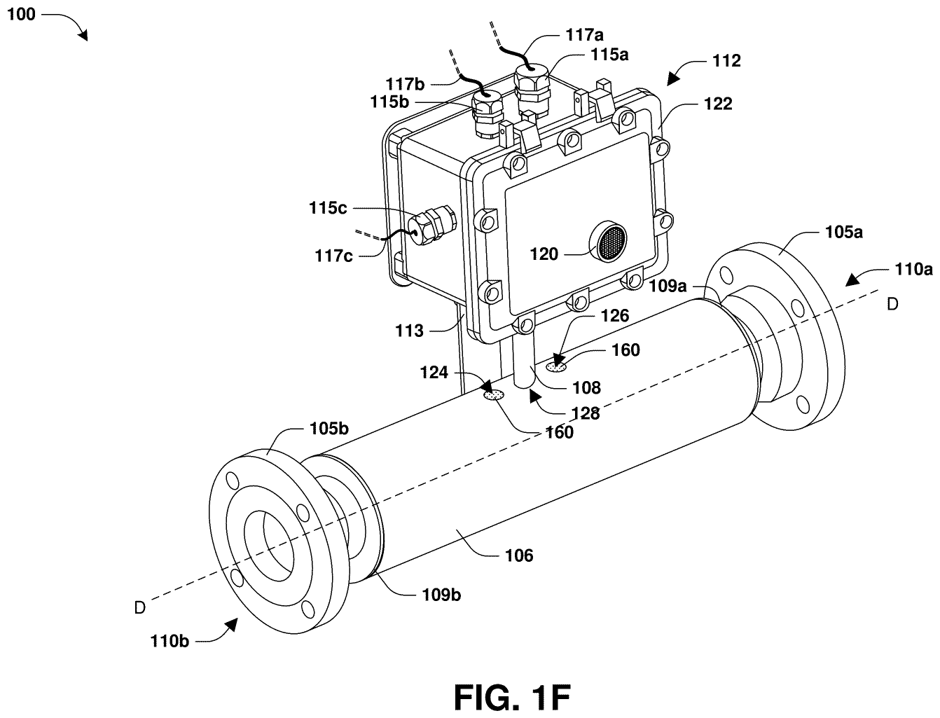

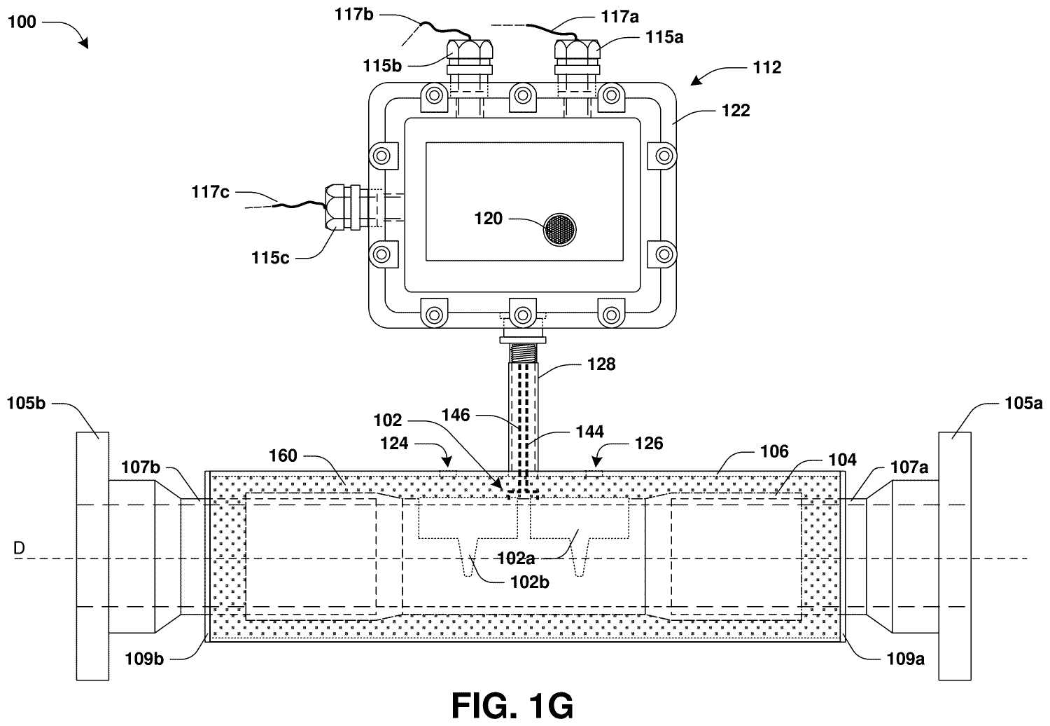

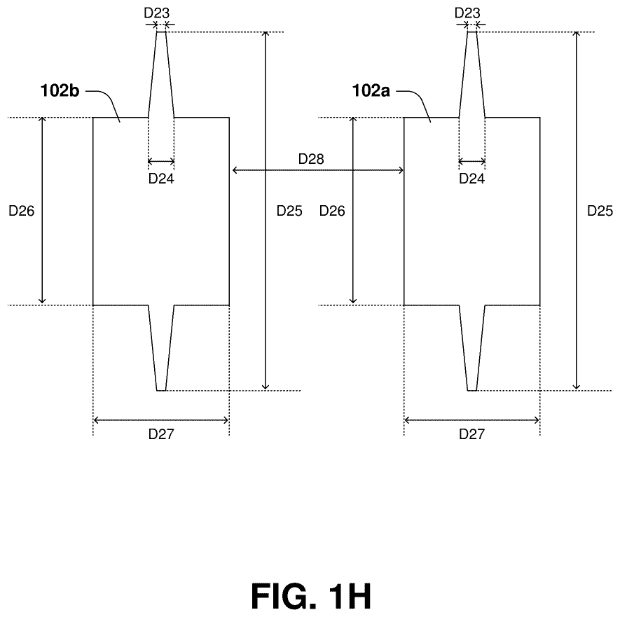

FIG. 1A illustrates an exploded view of an apparatus 100 (e.g., a non-intrusive capacitive sensor) showing individual components and relative positions of the individual components prior to assembly, in accordance with some embodiments. In some examples, the apparatus 100 may comprise a conduit 101 (e.g., a channel), a first electrode 102a (e.g., a first conductive element, a first capacitive plate, etc.), a second electrode 102b (e.g., a second conductive element, a second capacitive plate, etc.), a power source (e.g., a power supply) and/or a mixture evaluation device 112 (e.g., a sensing system, a composition analysis system, etc.). In some examples, the apparatus 100 may comprise a protective enclosure 122 (e.g., an explosion-proof enclosure) defining a first chamber configured to prevent igniting flammable gases and vapors surrounding the apparatus 100. In some examples, the conduit 101 may conduct a mixture (e.g., an immiscible liquid-liquid Mixture, a heterogeneous mixture, a suspension, an emulsion, etc.) along a flow path 103 (e.g., an inner space defined by the conduit 101). In some examples, the first electrode 102a may be placed (e.g., embedded) proximal (e.g., adjacent to and/or within a first threshold distance of the flow path 103, such as 0.5 centimeter or 5 centimeters) the flow path 103 defined by the conduit 101. In some examples, the second electrode 102b may be placed (e.g., embedded) proximal (e.g., adjacent to and/or within a second threshold distance of the flow path 103, such as 0.5 centimeter or 5 centimeters) the flow path 103. In some examples, the power source may apply (e.g., provide) a first voltage (e.g., an electrical potential) across the first electrode 102a and the second electrode 102b.

In some examples, the mixture evaluation device 112 may determine (e.g., measure) a first capacitance (e.g., a first capacitive value, a first electrical property, etc.) of a first capacitor 102 established by the first electrode 102a, the second electrode 102b and the mixture based upon the first capacitance. In some examples, the mixture evaluation device 112 may define capacitance of dielectric materials between the first electrode 102a and the second electrode 102b. In some examples, the mixture evaluation device 112 may determine one or more composition properties of the mixture based upon the first capacitance of the first capacitor 102. In some examples, the mixture evaluation device 112 may determine a composition property (e.g., a measure of one or more first substances in the mixture) of the mixture based upon the first capacitance of the first capacitor 102. In some examples, the measure of the one or more first substances may comprise a measure of a proportion (e.g., mixing percentage) and/or concentration of the one or more first substances in the mixture. In some examples, the composition property may be indicative of an amount (e.g., a quantity, a mass, a volume, etc.) of the one or more first substances in the mixture. In some examples, the first capacitor 102 may be an in-situ dielectric capacitor having a capacitance that may vary based upon changing a dielectric property of the mixture.

In some examples, the mixture evaluation device 112 may comprise a second capacitor (e.g., a reference capacitor) electrically connected to the first capacitor 102. In some examples, the mixture evaluation device 112 may charge (e.g., apply a voltage on) the first capacitor 102 using the power source during a first period of time (e.g., about 62 micro seconds). Alternatively and/or additionally, after charging the first capacitor 102, the mixture evaluation device 112 may electrically disconnect the power source from the first capacitor 102 during a second period of time (e.g., about 31 micro seconds) after the first period of time. Alternatively and/or additionally, following the second period of time, the mixture evaluation device 112 may transfer charge (e.g., electrical charge) from the first capacitor 102 to the second capacitor during a third period of time (e.g., about 62 micro seconds) after the second period of time. Alternatively and/or additionally, after transferring the electrical charge from the first capacitor 102 to the second capacitor, the mixture evaluation device 112 may measure one or more electrical parameters (e.g., a second voltage, a second electric field intensity, a second current, etc.) of the second capacitor, wherein the first capacitance of the first capacitor 102 may be determined based upon the one or more electrical parameters. For example, the first capacitance of the first capacitor 102 may be determined via comparing the voltage across the first capacitor 102 and the second voltage across the second capacitor using below formulas:

$$\{ \begin{matrix}C = \frac{Q}{V} \\ {Q}_{1} = {Q}_{2} \\ {C}_{1} {V}_{1} = {C}_{2} {V}_{2}\end{matrix}$$

wherein C is indicative of capacitance of a capacitor, Q is indicative of charge of the capacitor and V is indicative of voltage across the capacitor. Q₁ is charge of the first capacitor 102 and Q₂ is charge of the second capacitor. C₁ is capacitance of the first capacitor 102 and C₂ is capacitance of the second capacitor. V₁ is the voltage across the first capacitor 102 and V₂ is the second voltage across the second capacitor. In some examples, the charge initially stored in the first capacitor 102 may be transferred to the second capacitor, such that an amount of charge on the first capacitor 102 may be about equal to an amount of charge on the second capacitor following the transfer. In accordance with the principle of charge conservation during charge redistribution between capacitors, the product of the capacitance C₁ and the voltage V₁ of the first capacitor 102 is about equal to the product of the capacitance C₂ and the second voltage V₂ of the second capacitor, expressed as C₁V₁=C₂V₂. This relationship reflects that amount of the electrical charge transferred from the first capacitor 102 to the second capacitor is conserved, assuming negligible losses.

In some examples, the mixture evaluation device 112 may comprise a switch capacitor (e.g., a switch capacitor circuit, a precision capacitance-to-digital converter (CDC) chip such as an AD7745 chip or an AD7746 chip, and/or a high-resolution capacitive-to-digital converter (CDC) such as FDC 1004). In some examples, the mixture evaluation device 112, using the switch capacitor, may apply a first pulse to electrically connect the power source and the first capacitor 102 to charge the first capacitor 102. In some examples, the mixture evaluation device 112, using the switch capacitor, to apply a second pulse to electrically connect the first capacitor 102 and the second capacitor to transfer the electrical charge of the first capacitor 102 to the second capacitor.

In some examples, the mixture evaluation device 112 may comprise one or more analog switches, one or more capacitors, one or more operational amplifiers (OP AMPs) and/or one or more Analog-to-Digital convertors. In some examples, the mixture evaluation device 112 may apply the first pulse to: (i) electrically connect the power source and the first capacitor 102, and (ii) allow the power source to charge the first capacitor 102 in the first period of time. Alternatively and/or additionally, the mixture evaluation device 112 may apply a second pulse to: (i) electrically disconnect the power source and the first capacitor in the second period of time after the first period of time, and (ii) electrically connect the first capacitor 102 to the second capacitor for charging the second capacitor in the third period of time after the second period of time. In some examples, the one or more capacitors may provide current stabilization for the mixture evaluation device 112 in the second period of time and a fourth period of time after the third period of time. In some examples, the one or more operational amplifiers may provide voltage buffering for the mixture evaluation device 112 during charging and discharging the first capacitor 102 and the second capacitor. In some examples, the one or more Analog-to-Digital convertors may convert one or more analog signals to one or more digital signals. In some examples, the first pulse may be a first periodic pulse and the second pulse may be a second periodic pulse. In some examples the first periodic pulse and the second periodic pulse may be non-overlapping pulses and/or partially complementary. For example, when the first pulse is in a high value (e.g., a high logic state), the second pulse is in a low value (e.g., a low logic state, zero). However, there exist intervals during which both the first pulse and the second pulse may simultaneously be in the low value. This timing configuration ensures mutual exclusivity of high states while allowing for defined idle periods where neither pulse is active, which can be used for signal settling, isolation, or transition stabilization.

In some examples, the one or more analog switches may be configured to receive the first pulse to: (i) apply the electric connection between the power source and the first capacitor 102, and (ii) allow the power source to charge the first capacitor 102 in the first period of time. In some examples, the one or more analog switches may be configured to receive the second pulse to: (i) apply the electric disconnection between the power source and the first capacitor 102 in the second period of time after the first period of time, and (ii) apply the electric connection between the first capacitor 102 and the second capacitor for charging the second capacitor in the third period of time after the second period of time.

In some examples, the conduit 101 may comprise a first flange 105a (e.g., a first connector, a first fitting, a first mounting interface, etc.), a second flange 105b (e.g., a second connector, a second fitting, a second mounting interface, etc.), a non-conductive pipe 104 (e.g., an insulating pipe, a non-metallic pipe, a non-conductive tubing, etc.), a first connecting pipe 107a, a first hollow annular disk 109a, a second connecting pipe 107b, a second hollow annular disk 109b, a discharge pipe (not shown) and/or a conductive pipe 106. In some examples, the first flange 105a, the first connecting pipe 107a and/or the first hollow annular disk 109a may be combined to form a first flange assembly 110a. In some examples, the second flange 105b, the second connecting pipe 107b and/or the second hollow annular disk 109b may be combined to form a second flange assembly 110b.

In some examples, the first flange 105a may be connected to the first connecting pipe 107a. In some examples, the second flange 105b may be connected to the second connecting pipe 107b from one side and/or the discharge pipe from the other side. In some examples, the non-conductive pipe 104 may house a portion of the first connecting pipe 107a and/or a portion of the second connecting pipe 107b. In some examples, the first hollow annular disk 109a comprising a first central aperture (e.g., a first interior cavity) may house a second portion of the first connecting pipe 107a. In some examples, the second hollow annular disk 109b comprising a second central aperture (e.g., a second interior cavity) may house a second portion of the second connecting pipe 107b. In some examples, the discharge pipe may comprise a tubular structure designed to carry one or more substances (e.g., unwanted water, sludge, etc.) of the mixture away from the conduit 101. In some examples, the conductive pipe 106 may be connected to the first hollow annular disk 109a and/or the second hollow annular disk 109b. In some examples, the conductive pipe 106, the first hollow annular disk 109a and/or the second hollow annular disk 109b may provide a second chamber housing the non-conductive pipe 104, the first capacitor 102 (e.g., the first electrode 102a and/or the second electrode 102b), at least a portion of connecting wires (e.g., a first connecting wire, a second connecting wire) connected to the first capacitor 102, the portion of the first connecting pipe 107a and/or the portion of the second connecting pipe 107b. In some examples, an epoxy resin (e.g., a non-conductive material, an electrical insulating material, etc.) may be used to fill a space (e.g., a portion of the second chamber) between an outer surface of the non-conductive pipe 104 and an inner surface of the conductive pipe 106. In some examples, the conductive pipe 106 may comprise a plurality of holes (e.g., a first hole 124, a second hole 126 and a third hole 128). In some examples, the third hole 128 may accommodate a protective tube 108, which is configured to connect the conduit 101 to the protective enclosure 122 and/or shield (e.g., protect) the connecting wires. In some examples, the epoxy resin may be introduced into the space between the outer surface of the non-conductive pipe 104 and the inner surface of the conductive pipe 106 through the first hole 124. Alternatively or additionally, as the epoxy resin is inserted (e.g., injected), air or other gases present in the space may be vented out through the second hole 126. In some examples, the protective enclosure 122 may comprise a base 113, wherein the base 113 may be connected to the conduit 101 and/or another location. In some examples, the base 113 may be configured to support at least a portion of weight of the apparatus 100. In some examples, the protective enclosure 122 may comprise a user-operated switch 120 configured to manually control a state of a valve. In some examples, the apparatus 100 may be an electrical capacitance tomography (ECT) sensor that may use ECT technique. Although FIG. 1A illustrates the first capacitor 102, any number of capacitors placed (e.g., embedded) on outer surface of the non-conductive pipe are contemplated in the present disclosure.

FIG. 1B illustrates a perspective view 130a, a side view 134a and a cross-sectional view 132a of the first flange assembly 110a of the apparatus 100, in accordance with some embodiments. The cross-sectional view 132a of the first flange assembly 110a is taken along line A-A. In some examples, the first flange assembly 110a may comprise the first flange 105a, the first hollow annular disk 109a and/or the first connecting pipe 107a. The first flange 105a may be aligned (e.g., axially aligned) with the first connecting pipe 107a, such that a central axis of the first flange 105a may be co-linear with a central axis of the first connecting pipe 107a. The first connecting pipe 107a may be positioned at least partially within the first central aperture of the first hollow annular disk 109a, such that the first hollow annular disk 109a may surround outer periphery of the first connecting pipe 107a. The first flange 105a, the first hollow annular disk 109a and/or the first connecting pipe 107a may be fixedly or removably coupled depending on application requirements. As shown in FIG. 1A, the second flange assembly 110b may comprise the second flange 105b, the second hollow annular disk 109b and/or the second connecting pipe 107b. The second flange 105b may be aligned (e.g., axially aligned) with the second connecting pipe 107b, such that a central axis of the second flange 105b may be co-linear with a central axis of the second connecting pipe 107b. The second connecting pipe 107b may be positioned at least partially within the second central aperture of the second hollow annular disk 109b, such that the second hollow annular disk 109b may surround outer periphery of the second connecting pipe 107b. The second flange 105b, the second hollow annular disk 109b and/or the second connecting pipe 107b may be fixedly or removably coupled depending on application requirements.

In some examples, dimension D1 (shown in FIG. 1B) is between about 40 millimeters to about 120 millimeters, such as about 80 millimeters. In some examples, dimension D2 (shown in FIG. 1B) is between about 95 millimeters to about 285 millimeters, such as about 190 millimeters. In some examples, dimension D3 (shown in FIG. 1B) is between about 44 millimeters to about 132 millimeters, such as about 88 millimeters. In some examples, dimension D4 (shown in FIG. 1B) is between about 75 millimeters to about 225 millimeters, such as about 150 millimeters. In some examples, dimension D5 (shown in FIG. 1B) is between about 2 millimeters to about 10 millimeters, such as about 5.5 millimeters. In some examples, dimension D6 (shown in FIG. 1B) is between about 70 millimeters to about 290 millimeters, such as about 137 millimeters. In some examples, dimension D7 (shown in FIG. 1B) is between about 1 millimeter to about 6 millimeters, such as about 3 millimeters.

FIG. 1C illustrates a perspective view 130b, a side view 134b and a cross-sectional view 132b of the non-conductive pipe 104 of the apparatus 100, in accordance with some embodiments. The cross-sectional view 132b of the non-conductive pipe 104 is taken along line B-B. In some examples, the non-conductive pipe 104 may comprise a first portion 151, a second portion 152, a third portion 153, a fourth portion 154 and/or a fifth portion 155. In some examples, the first portion 151 may comprise a circular cylinder shape. In some examples, the second portion 152 may comprise a conical cylinder shape. In some examples, the third portion 153 may comprise a circular cylinder shape having a diameter smaller than a diameter of the first portion 151. In some examples, the fourth portion 154 may comprise a conical shape. In some examples, the fifth portion 155 may comprise a cylindrical shape, wherein a diameter of the fifth portion 155 may be larger than the diameter of the third portion 153 and/or about equal the diameter of the first portion 151. Although FIG. 1C shows circular cross-section for all portions with different diameters, any other cross-sectional shapes such as triangular cross-section, square cross-section, oval cross-section, and other polygonal cross-sections with other diameters are contemplated in the present disclosure. In some examples, the non-conductive pipe 104 may comprise a first opening 138 and/or a second opening 136, wherein the mixture may enter the non-conductive pipe via the first opening 138 and may exit the non-conductive pipe 104 via the second opening 136. In some examples, the non-conductive pipe 104 may define a portion of the flow path 103. In some examples, the non-conductive pipe 104 may be made of one or more materials that are electrically non-conductive. In some examples, the one or more materials may comprise Glass Reinforced Epoxy (GRE), Aramid Fibers, Fiber Glasses and/or Fiber Reinforced Polymers (FRPs). In some examples, the Aramid Fibers may comprise Kevlar, Twaron and/or Nomex.

In some examples, dimension D14 (shown in FIG. 1C) is between about 50 millimeters to about 150 millimeters, such as about 100 millimeters. In some examples, dimension D15 (shown in FIG. 1C) is between about 10 millimeters to about 30 millimeters, such as about 20 millimeters. In some examples, dimension D16 (shown in FIG. 1C) is between about 100 millimeters to about 300 millimeters, such as about 210 millimeters. In some examples, dimension D17 (shown in FIG. 1C) is between about 200 millimeters to about 600 millimeters, such as about 450 millimeters. In some examples, dimension D18 (shown in FIG. 1C) is between about 35 millimeters to about 100 millimeters, such as about 78 millimeters. In some examples, dimension D19 (shown in FIG. 1C) is between about 40 millimeters to about 110 millimeters, such as about 87 millimeters. In some examples, dimension D20 (shown in FIG. 1C) is between about 50 millimeters to about 150 millimeters, such as about 97.5 millimeters. In some examples, dimension D21 (shown in FIG. 1C) is between about 40 millimeters to about 120 millimeters, such as about 88.5 millimeters. In some examples, dimension D22 (shown in FIG. 1C) is between about 2 millimeters to about 7 millimeters, such as about 4.5 millimeters.

FIG. 1D illustrates a perspective view 130c, a side view 134c and a cross-sectional view 132c of the conductive pipe 106 of the apparatus 100, in accordance with some embodiments. The cross-sectional view 132c of the conductive pipe 106 is taken along line C-C. As shown in FIG. 1D, the conductive pipe 106 may comprise a circular cylinder shape. Although FIG. 1D shows circular cross-section for the conductive pipe 106, any other cross-sectional shapes such as triangular cross-section, square cross-section, oval cross-section, and other polygonal cross-sections are contemplated in the present disclosure. In some examples, a first side of the conductive pipe 106 may be coupled to the first hollow annular disk 109a and a second side of the conductive pipe 106 may be coupled to the second hollow annular disk 109b. In some examples, the conductive pipe 106 may be used as a shield for capacitors (e.g., the first capacitor 102 inside the conductive pipe 106) from external noise source. The conductive pipe 106 may be cylindrical or polygonal in shape and may be constructed from metals such as copper, aluminum, or a conductive polymer.

In some examples, dimension D8 (shown in FIG. 1D) is between about 5 millimeters to about 18 millimeters, such as about 12.7 millimeters. In some examples, dimension D9 (shown in FIG. 1D) is between about 3 millimeters to about 9 millimeters, such as about 6 millimeters. In some examples, dimension D10 (shown in FIG. 1D) is between about 3 millimeters to about 9 millimeters, such as about 6 millimeters. In some examples, dimension D11 (shown in FIG. 1D) is between about 70 millimeters to about 210 millimeters, such as about 139 millimeters. In some examples, dimension D12 (shown in FIG. 1D) is between about 1 millimeter to about 6 millimeters, such as about 3 millimeters. In some examples, dimension D13 (shown in FIG. 1D) is between about 250 millimeters to about 750 millimeters, such as about 500 millimeters.

FIG. 1E illustrates a perspective view of the protective enclosure 122 of the apparatus 100, in accordance with some embodiments. In some examples, the protective enclosure 122 may comprise a body defining a third chamber to house the mixture evaluation device 112. In some examples, the protective enclosure 122 may comprise a first gland 115a (e.g., a first cable gland), a second gland 115b (e.g., a second cable gland) and/or a third gland 115c (e.g., a third cable gland). In some examples, the first gland 115a may allow a first cable 117a to exit the protective enclosure 122 and/or to be connected to the power source. In some examples, the power source may deliver a voltage (e.g., an electrical potential) to the mixture evaluation device 112 through the first cable 117a. In some examples, the first cable 117a may comprise two or more first connectors (e.g., two or more first connecting wires). In some examples, the second gland 115b may allow a second cable 117b to exit the protective enclosure 122 and/or to be connected to a control room. The mixture evaluation device 112 may send its recorded data to the control room through the second cable 117b. In some examples, the second cable 117b may comprise two or more second connectors (e.g., two or more second connecting wires). In some examples, the third gland 115c may allow a third cable 117c to exit the protective enclosure 122 and/or to be connected to a valve (e.g., a control valve, an On-Off valve, a Normal Close valve, etc.). The mixture evaluation device 112 may send a control signal (e.g., an open command, a close command) to the valve through the third cable 117c. In some examples, the third cable 117c may comprise two or more third connectors (e.g., two or more third connecting wires). In some examples, the protective enclosure 122 may comprise the protective tube 108. The protective tube 108 may be configured to protect the connecting wires (e.g., the first connecting wire (shown with reference number 144), the second connecting wire (shown with reference number 146)) as a shield. In some examples, the first connecting wire 144 may be connected to the first electrode 102a from one side and/or to the mixture evaluation device 112 from the other side. In some examples, the first connecting wire 144 may extend from within the conductive pipe 106, then may pass through the protective tube 108 and finally may enter the mixture evaluation device 112. In some examples, the second connecting wire 146 may be connected to the second electrode 102b from one side and/or to the mixture evaluation device 112 from the other side. In some examples, the second connecting wire 146 may extend from within the conductive pipe 106, then may pass through the protective tube 108 and finally may enter the mixture evaluation device 112.

FIG. 1F illustrates a perspective view of the apparatus 100, in accordance with some embodiments. All components illustrated in the exploded view of FIG. 1A are shown fully assembled in their final configuration in FIG. 1F. FIG. 1G illustrates a cross-sectional view of the apparatus 100, in accordance with some embodiments. The cross-sectional view of the apparatus 100 is taken along line D-D of FIG. 1F. As shown in FIG. 1G, the epoxy resin (shown with reference number 160) may be injected into the space between the outer surface of the non-conductive pipe 104 and the inner surface of the conductive pipe 106. FIG. 1H illustrates a top view of the first electrode 102a and the second electrode 102b in unfolded configurations, prior to being placed (e.g., embedded) on the outer surface of the non-conductive pipe 104, in accordance with some embodiments. In some examples, the first electrode 102a and the second electrode 102b may be configured to be folded or wrapped onto the outer surface of the non-conductive pipe 104. In some examples, the first electrode 102a and the second electrode may be placed (e.g., embedded) on the outer surface of the non-conductive pipe 104 in opposite sides. In some examples, the first electrode 102a and the second electrode may be placed (e.g., embedded) on the outer surface of the non-conductive pipe 104 in same sides. In some examples, the first electrode 102a and the second electrode may be wrapped partially or fully around the outer side of the non-conductive pipe 104 in same sides.

In some examples, dimension D23 (shown in FIG. 1H) is between about 2 millimeters to about 6 millimeters, such as about 4 millimeters. In some examples, dimension D24 (shown in FIG. 1H) is between about 6 millimeters to about 18 millimeters, such as about 12 millimeters. In some examples, dimension D25 (shown in FIG. 1H) is between about 100 millimeters to about 300 millimeters, such as about 210 millimeters. In some examples, dimension D26 (shown in FIG. 1H) is between about 50 millimeters to about 160 millimeters, such as about 110 millimeters. In some examples, dimension D27 (shown in FIG. 1H) is between about 25 millimeters to about 75 millimeters, such as about 50 millimeters. In some examples, dimension D28 (shown in FIG. 1H) is between about 25 millimeters to about 75 millimeters, such as about 50 millimeters. In some examples, a thickness of the first electrode 102a is between about 1 millimeter to about 6 millimeters, such as about 3 millimeters. In some examples, a thickness of the second electrode 102b is between about 1 millimeter to about 6 millimeters, such as about 3 millimeters. In some examples, the dimension D28 may influence capacitance value of the first capacitor 102. For example, the first capacitor 102 with smaller distance between the electrodes may comprise a higher capacitance and the first capacitor 102 with larger distance between the electrodes may comprise a lower capacitance and/or a lower sensitivity. Although FIGS. 1B-1D and FIG. 1H illustrate the dimensions D1, D2, D3, D4, D5, D6, D7, D8, D9, D10, D11, D12, D13, D14, D15, D16, D17, D18, D19, D20, D21, D22, D23, D24, D25, D26, D27 and/or D28, any other values for the dimensions D1, D2, D3, D4, D5, D6, D7, D8, D9, D10, D11, D12, D13, D14, D15, D16, D17, D18, D19, D20, D21, D22, D23, D24, D25, D26, D27 and/or D28, based upon application of the apparatus 100, are contemplated in the present disclosure.

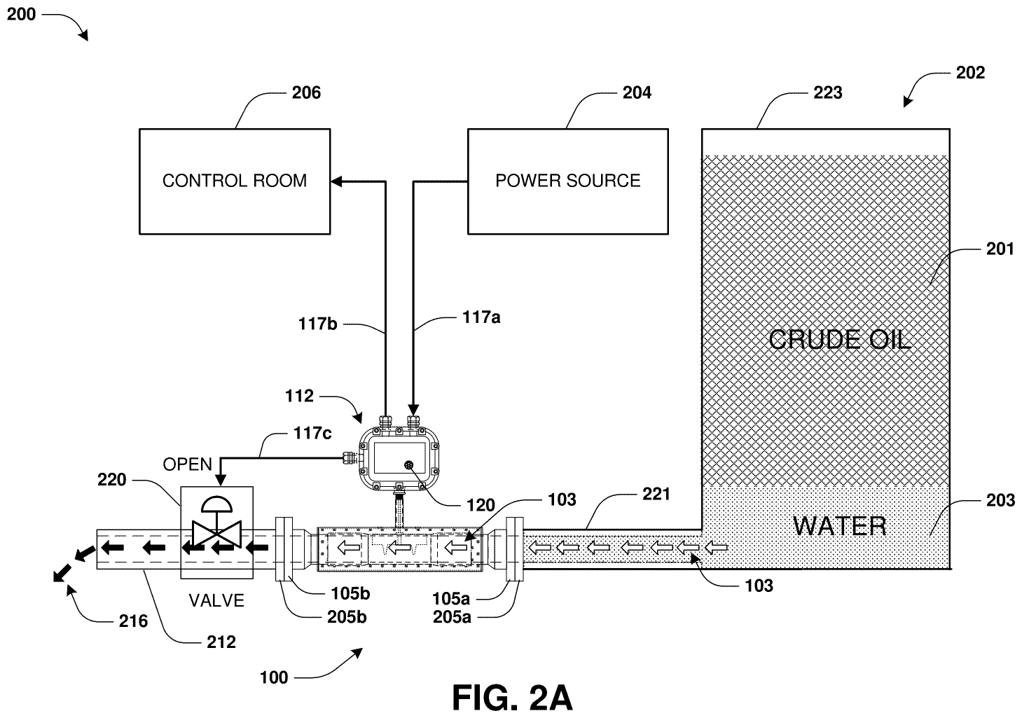

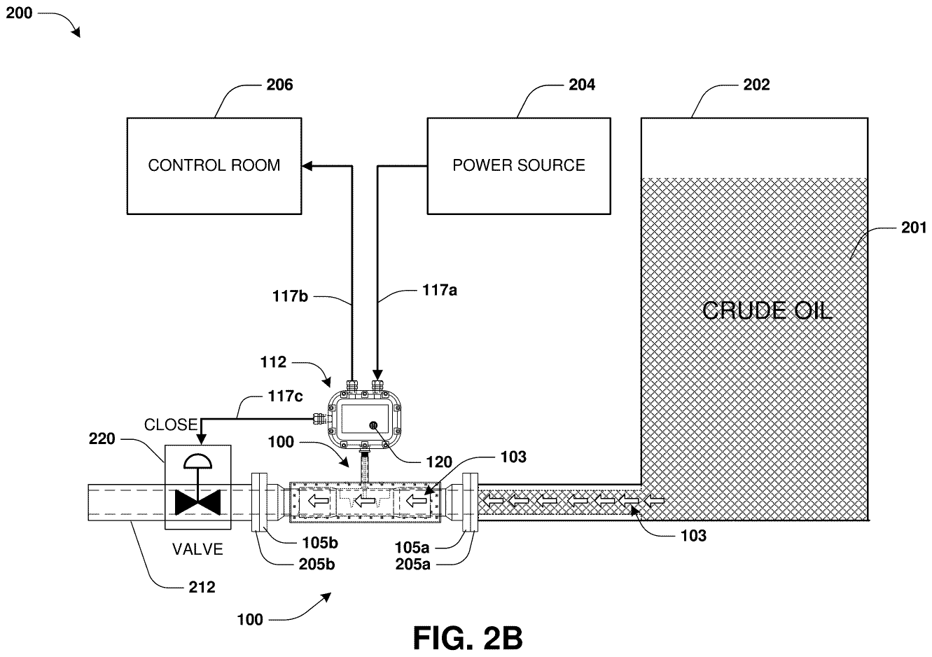

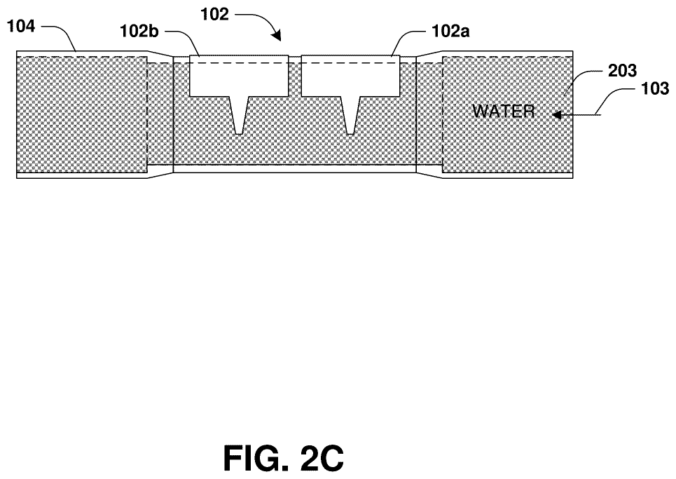

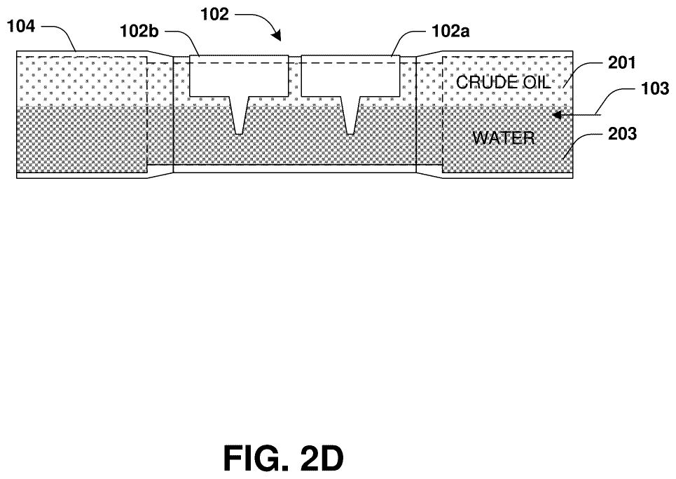

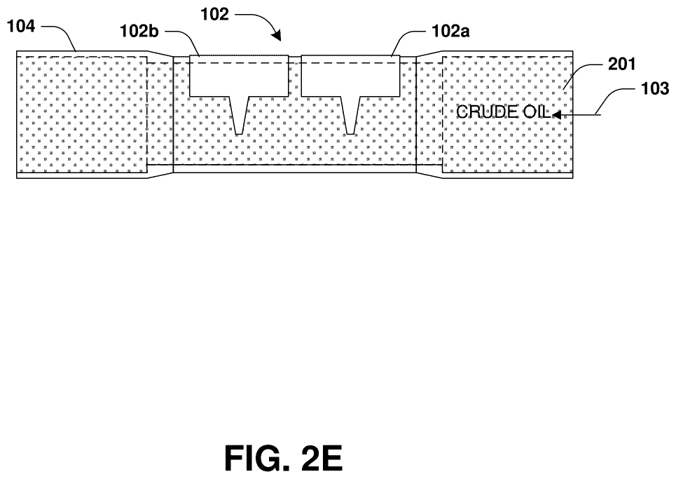

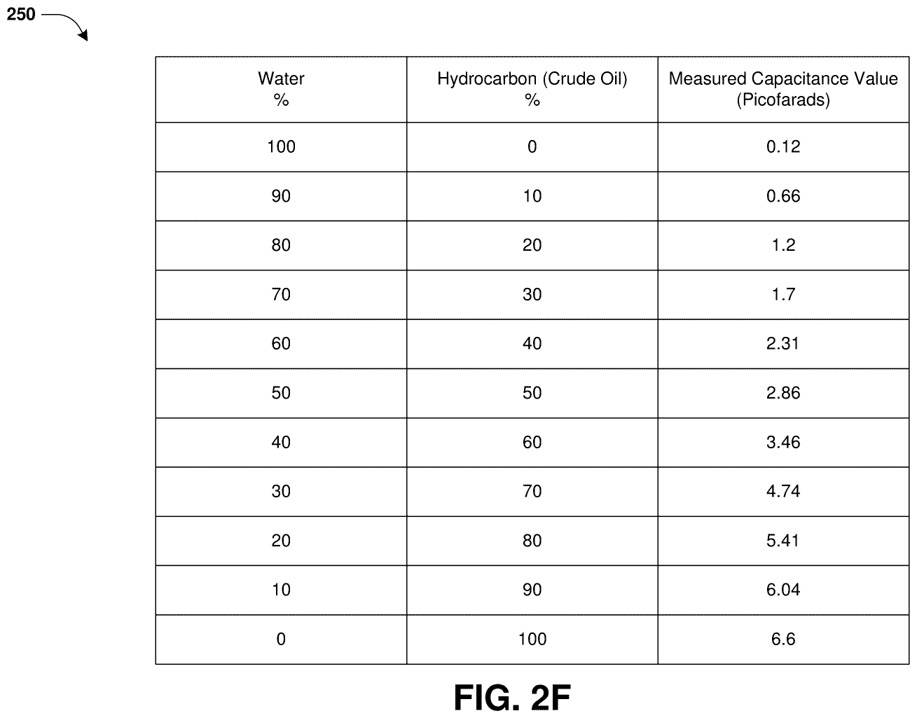

FIGS. 2A-2B illustrate a schematic view of a system 200 (e.g., a capacitive sensing system) incorporating the apparatus 100, wherein the apparatus 100 is configured to actuate a valve 220 (e.g., an On-Off valve, a Normal Close valve, a control valve, etc.) based upon detecting one or more composition properties of a first mixture (e.g., a first fluid mixture, a first crude oil-water mixture, a first mixture of two or more substances, a first mixture of a first substance 201 such as crude oil and a second substance 203 such as Water, etc.), in accordance with some embodiments. In some examples, the system 200 may comprise the apparatus 100, a control room 206, the valve 220 and/or a storage tank 202. In some examples, the storage tank 202 (e.g., a hydrocarbon tank) may comprise a tank body 223 and/or a drain 221 (e.g., a drain system, a water drain tube, a sludge drain tube, etc.). In some examples, the storage tank 202 may be a hydrocarbon tank which may be a specially designed vessel used to safely store flammable or volatile petroleum products such as crude oil, gasoline, diesel, jet fuel, or other refined or unrefined hydrocarbons. In some examples, the storage tank 202 may comprise a liquefied natural gas (LNG) tank, a liquefied petroleum gas (LPG) tank, a chemical storage tank, a water storage tank, a slop tank, a waste oil tank, a bitumen tank, an aviation fuel tank, and/or a biofuel tank. In some examples, the drain 221 of the storage tank 202 may be configured to remove unwanted substances, such as water, sludge, or sediment, that may accumulate at the bottom of the storage tank 202 during storage. In some examples, the drain 221 may be positioned at the lowest point of the storage tank 202 to facilitate gravity-assisted discharge and may include a valve mechanism to manually and/or automatically remove the unwanted substances. In some examples, the storage tank 202 may comprise the first mixture inside the tank body 223. As shown in FIG. 2A, the first mixture comprises the first substance 201 and/or the second substance 203. For example, the second substance 203 may be an unwanted substance and the system 200 may be configured to discharge the second substance 203 to purify the first substance 201. In some examples, the first mixture may comprise a first set of substances and/or a second set of substances, wherein the second set of substances may be the unwanted substances and the system 200 may be configured to discharge the second set of substances to purify the first set of substances.

In some examples, the drain 221 may comprise a third flange 205a (e.g., a third connector) configured to be connected to the first flange 105a. In some examples, the system 200 may comprise the discharge pipe (shown with reference number 212) configured to conduct the first mixture (e.g., a portion of the first substance 201 and/or a portion of the second substance 203) along a second flow path 216 and/or out of the conduit 101. In some examples, the discharge pipe 212 may be connected to another storage tank (e.g., a second storage tank) configured to store a discharged mixture. In some examples, the discharge pipe 212 may comprise a fourth flange 205b (e.g., a fourth connector) configured to be connected to the second flange 105b. In some examples, the valve 220 may be coupled (e.g., connected) to the discharge pipe 212 to allow the first mixture to exit the storage tank 202 and/or enter the second storage tank. In some examples, when the valve 220 is opened (as shown in FIG. 2A), the valve 220 may allow the first mixture (e.g., a second portion of the first substance 201 and/or a second portion of the second substance 203) to flow through the flow path 103 and/or the second flow path 216. In some examples, the flow path 103 may allow the first mixture to be conducted inside the drain 221 and/or to be reached the valve 220. Alternatively and/or additionally, the valve 220 may allow the first mixture to flow inside the conduit 101 and/or to enter the discharge pipe 212. Alternatively and/or additionally, the discharge pipe 212 may allow the first mixture to flow outward and/or be directed into the second storage tank.

In some examples, the mixture evaluation device 112 may allow the power source (shown with reference number 204) to periodically apply the first voltage across the first electrode 102a and the second electrode 102b via the first cable 117a, the first connecting wire 144 and/or the second connecting wire 146 to periodically charge the first capacitor 102. Alternatively and/or additionally, after the periodically applying the first voltage, the mixture evaluation device 112 may determine the one or more composition properties of the first mixture flowing along the flow path 103 inside the conduit 101. While determining the one or more composition properties, the mixture evaluation device 112 may compare each determined composition property of the one or more properties with a threshold composition property. In an example, a first composition property may be determined based upon determining the first capacitance of the first capacitor 102 and the threshold composition property may be a threshold capacitance (e.g., a predetermined capacitive value).

In some examples, the mixture evaluation device 112 may allow the valve 220 to be opened in response to the first capacitance (e.g., a capacitance value about 0.3 picofarads and/or a capacitance value less than the threshold capacitance) of the first capacitor 102 not meeting (e.g., not exceeding) the threshold capacitance (e.g., a predetermined capacitance value about 0.66 picofarads). In some examples, the mixture evaluation device 112 may allow the valve 220 to be closed in response to the first capacitance (e.g., a capacitance value about 0.66 picofarads and/or a capacitance value about equal to or more than the threshold capacitance) of the first capacitor 102 meeting (e.g., exceeding) the threshold capacitance (e.g., the predetermined capacitance value about 0.66 picofarads).

In some examples, the mixture evaluation device 112 may control the valve 220 based upon the comparison of each composition property with the threshold composition property. In some examples, the one or more composition properties are indicative of a measure of one or more substances in the first mixture. In some examples, the first composition property of the one or more composition properties may be indicative of a first proportion (e.g., a first mixing percentage) and/or a first concentration of each substance corresponding to the two or more substances.

For example, the threshold capacitance may be indicative of the first composition property. Alternatively and/or additionally, the first composition property may be indicative of a first concentration of the first substance 201 such as crude oil in the first mixture, and/or a first concentration of the second substance 203 such as water in the in the first mixture. In some examples, the threshold composition property may be defined as a percentage of crude oil relative to total composition (e.g., composition of crude oil and water) of the first mixture and/or a percentage of water relative to the total composition of the first mixture (e.g., composition of crude oil and water). For example, the threshold composition property may be defined as about 20% crude oil and/or about 80% water. In some examples, the percentage of crude oil may be a volume percentage of crude oil associated with the first mixture and/or a weight percentage of crude oil associated with the first mixture. In some examples, the percentage of water may be a volume percentage of water associated with the first mixture and/or a weight percentage of water associated with the first mixture. In some examples, the mixture evaluation device 112 may allow the valve 220 to be opened in response to the first composition property (e.g., 10% crude oil and/or 90% water) not meeting (e.g., not exceeding) the threshold composition property (e.g., 20% crude oil and/or 80% water). In some examples, the mixture evaluation device 112 may allow the valve 220 to be closed in response to the first composition property (e.g., 20% crude oil and/or 80% water) meeting (e.g., exceeding) the threshold composition property (e.g., 20% crude oil and/or 80% water). Although FIG. 2A illustrates two substances such as crude oil and water for the first mixture with the threshold composition property of 20% crude oil and/or 80% water, any number of substances with any value for threshold composition property are contemplated in the present disclosure.

In some examples, the mixture evaluation device 112 may allow the valve 220 to be closed in response to a second composition property meeting a second threshold composition property (e.g., 100% crude oil and/or 0% water). As shown in FIG. 2B, the valve 220 of the system 200 is in closed-state. For example, when a concentration (e.g., mixture percentage) of water reaches about a predetermined threshold (e.g., 0% water), the mixture evaluation device 112 may send a control signal (e.g., a close signal) to close the valve 220, which is indicative of a purified crude oil (e.g., a crude oil with a purity of about 100%) remaining in the storage tank 202. Although FIG. 2B illustrates a purity of about 100% for the crude oil stored in the storage tank 202, any number of purities are contemplated in the present disclosure.

FIGS. 2C-2E illustrate movement of the first mixture within the non-conductive pipe 104 associated with the apparatus 100, in accordance with some embodiments. FIG. 2C illustrates the first mixture containing 100% water and/or 0% crude oil, flowing through the flow path 103 at a tenth time, in accordance with some embodiments. FIG. 2D illustrates the first mixture containing 60% water and/or 40% crude oil, flowing through the flow path 103 at an eleventh time, in accordance with some embodiments. FIG. 2E illustrates the first mixture containing 0% water and/or 100% crude oil, flowing through the flow path 103 at a twelfth time, in accordance with some embodiments.

FIG. 2F illustrates a table 250 presenting varying concentration (e.g., mixture percentage) of the first substance 201 (e.g., crude oil) and the second substance 203 (e.g., water) in the first mixture and corresponding capacitances measured by the apparatus 100, in accordance with some embodiments. In some examples, the table 250 may be a calibration table in which each measured capacitance may be indicative of concentration of the two or more substances (e.g., the first substance 201, the second substance 203, etc.) in the first mixture. For example, a first measured capacitance of about 0.66 picofarads may correspond to the first mixture at a thirteenth time containing 10% water and/or 90% crude oil. In another example, a second measured capacitance of about 6.04 picofarads may correspond to the first mixture at a fourteenth time containing 90% water and/or 10% crude oil. In some examples, the mixture evaluation device 112 may be calibrated by the calibration table. In some examples, the mixture evaluation device 112, based upon comparing a measured capacitance with a predefined threshold capacitance, may send a control signal to open or close the valve 220. In some examples, the predefined threshold capacitance may be indicative of the threshold composition property. For clarity, FIGS. 2C-2E illustrate a simplified view that shows the non-conductive pipe 104 without showing other components of the conduit 101, the mixture evaluation device 112 and/or the power source 204.

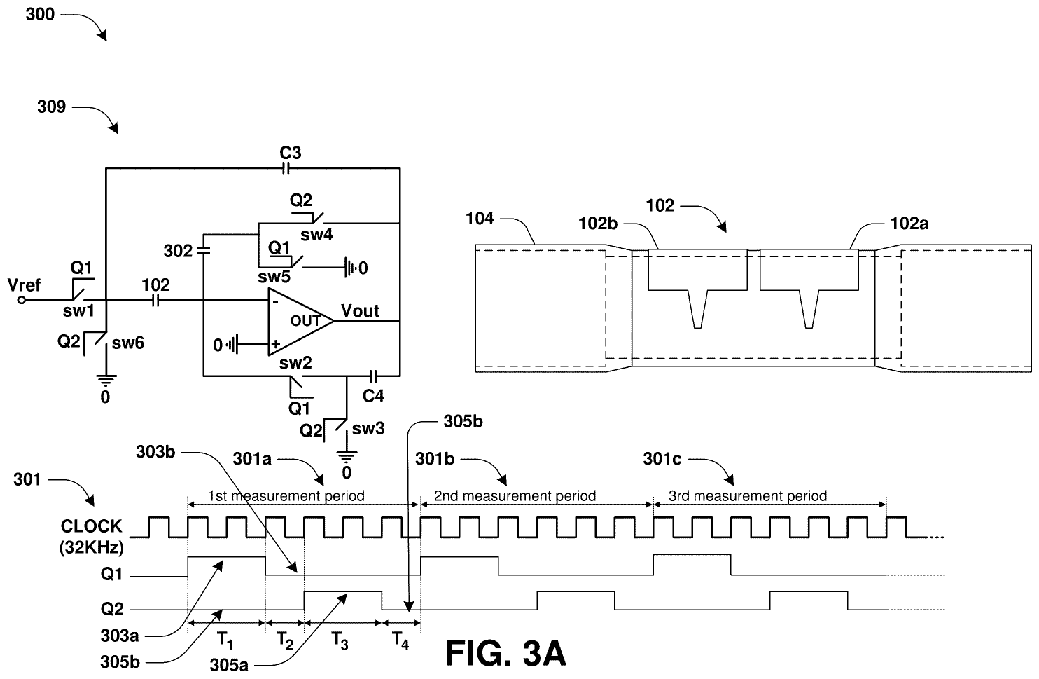

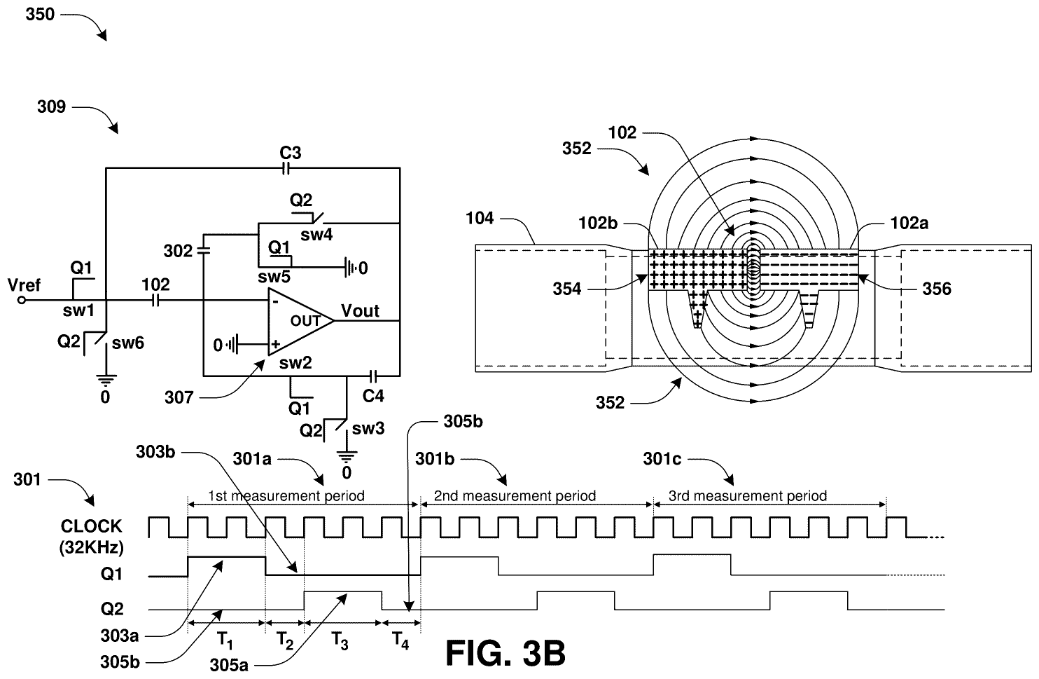

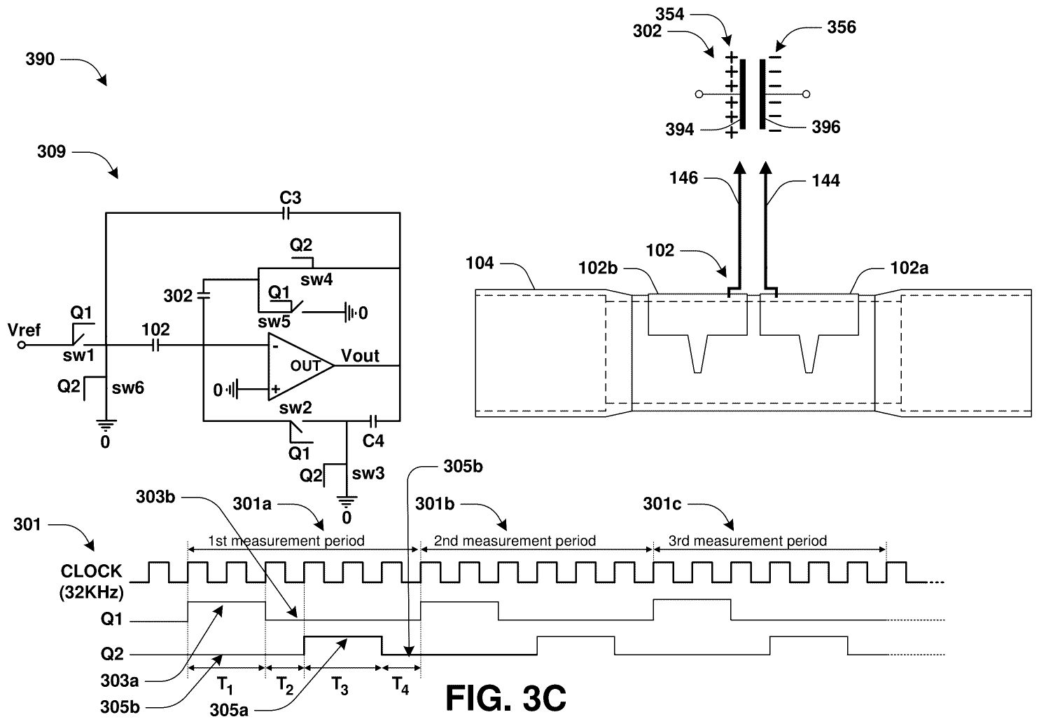

FIGS. 3A-3C illustrate various stages of charging and/or discharging the first capacitor 102 of the apparatus 100 using the mixture evaluation device 112, in accordance with some embodiments. FIG. 3A illustrates a first stage 300, wherein the first stage 300 is when the apparatus 100 and/or the mixture evaluation device 112 are in Off-mode (e.g., turned off). In some examples, the mixture evaluation device 112 may comprise the switch capacitor (shown with reference number 309). The Off-mode of the apparatus 100 may be a mode in which the switch capacitor 309 may not work. FIG. 3B illustrates a second stage 350, wherein the second stage 350 is when the apparatus 100 and/or the mixture evaluation device 112 are in On-mode (e.g., turned on) and the mixture evaluation device 112 charges the first capacitor 102 using the power source 204. FIG. 3C illustrates a third stage 390, wherein the third stage 390 is when the apparatus 100 and/or the mixture evaluation device 112 are in On-mode (e.g., turned on) and the mixture evaluation device 112 discharges the first capacitor 102 to transmit the charges of the first capacitor 102 to the second capacitor (shown with reference number 302).

In some examples, during the second stage 350, the switch capacitor 309 may allow the mixture evaluation device 112 to apply a first pulse Q1 to electrically connect the power source 204 and the first capacitor 102 to charge the first capacitor 102. In some examples, the first pulse Q1 may comprise a high value 303a (e.g., high logic state) in the first period of time (shown with reference number T₁) and/or a low value 303b (e.g., low logic state, zero) in the second period of time (shown with reference number T₂). In some examples, one or more clocks comprising one or more frequencies may be used in the switch capacitor 309. For example, the switch capacitor 309 may utilize a first clock 301 (e.g., a 32 Kilo Hertz clock) to determine the first pulse Q1 based upon the first clock 301. In some examples, the first clock 301 with a first frequency (e.g., about 32 Kilo Hertz) may comprise one or more measurement periods (e.g., a first measurement period 301a, a second measurement period 301b, a third measurement period 301c and/or etc.). In some examples, each measurement period of the one or more measurement periods may be about 186 microseconds. For example, the first measurement period 301a is about 186 microseconds. In some examples, the first clock 301 in each measurement period of the one or more measurement periods may comprise the first period of time T₁, the second period of time T₂, the third period of time (shown with reference number T₃) and/or the fourth period of time (shown with reference number T₄). In an example, the first period of time T₁ associated with the first clock 301 may be about 62 microseconds, the second period of time T₂ associated with the first clock 301 may be about 31 microseconds, the third period of time T₃ associated with the first clock 301 may be about 62 microseconds and the fourth period of time T₄ associated with the clock 301 may be about 31 microseconds.

In some examples, during the third stage 390, the switch capacitor 309 may allow the mixture evaluation device 112 to apply a second pulse Q₂ to electrically disconnect the power source 204 and the first capacitor 102 and/or electrically connect the first capacitor 102 to the second capacitor 302 to charge the second capacitor 302. In some examples, the second pulse Q₂ may comprise a high value 305a in the third period of time T₃ and/or a low value 305b in the fourth period of time T₄. In some examples, the first pulse Q₁ may be the first periodic pulse and the second pulse Q₂ may be the second periodic pulse. In some examples the first periodic pulse and the second periodic pulse may be the non-overlapping pulses and/or partially complementary. For example, when the first pulse Q₁ is the high value 303a, the second pulse Q₂ is the low value 305b. However, there may exist intervals during which the first pulse Q₁ is the low value 303b and simultaneously the second pulse Q₂ is the low value 305b. In an example, the first pulse Q₁ is about zero in the second period of time T₂, the third period of time T₃ and/or the fourth period of time T₄. In an example, the second pulse Q₂ is about zero in the first period of time T₁, the second period of time T₂ and/or the fourth period of time T₄.

In some examples, the mixture evaluation device 112 may comprise the one or more analog switches (a first analog switch sw1, a second analog switch sw2, a third analog switch sw3, a fourth analog switch sw4, a fifth analog switch sw5 and/or a sixth analog switch sw6), the one or more capacitors (e.g., the second capacitor 302, a third capacitor C3 and/or a fourth capacitor C4), the one or more operational amplifiers (e.g., an operational amplifier 307) and/or the one or more Analog-to-Digital convertors (not shown). In some examples, after applying the first pulse Q1, the first analog switch sw1, the second analog switch sw2 and/or the fifth analog switch sw5 may be turned on (e.g., activated). Alternatively and/or additionally, the first pulse Q1 may allow the power source 204 to be electrically connected to the first capacitor 102. After connecting the power source 204 and the first capacitor 102, the power source 204 may apply the first voltage (e.g., Vref) across the first electrode 102a and the second electrode 102b. Alternatively and/or additionally, the first capacitor 102 may be charged in the first period of time T₁. Alternatively and/or additionally, the power source 204 and the first capacitor 102 may be disconnected in the second period of time T₂.

Alternatively and/or additionally, after disconnecting the power source 204 and the first capacitor 102, the second pulse Q2 may be applied by the switch capacitor 309. After applying the second pulse Q2, the third analog switch sw3, the fourth analog switch sw4 and/or the sixth analog switch sw6 may be turned on (e.g., activated). Alternatively and/or additionally, the second pulse Q2 may allow the first capacitor 102 to be electrically connected to the second capacitor 302. After connecting the first capacitor 102 and the second capacitor 302, a first plurality of charges 354 (e.g., a first plurality of positive charges) associated with the first electrode 102a may be transferred (e.g., transmitted) to an electrode 394 of the second capacitor 302 and a second plurality of charges 356 (e.g., a first plurality of negative charges) of the second electrode 102b may be transferred to an electrode 396 of the second capacitor 302. Alternatively and/or additionally, the second capacitor 302 may be charged in the third period of time T₃. Alternatively and/or additionally, the first capacitor 102 and the second capacitor 302 may be disconnected in the fourth period of time T₄. Alternatively and/or additionally, during or after the fourth period of time T₄, the mixture evaluation device 112 may measure the first capacitance associated with the first capacitor 102 in the first measurement period 301a. Alternatively and/or additionally, after measuring the first capacitance, the mixture evaluation device 112 may compare the first capacitance with the threshold capacitance. After comparing the first capacitance and the threshold capacitance, the mixture evaluation device 112 may send: (i) a first control signal to allow the valve 220 to be opened based upon the first capacitance not meeting (e.g., not exceeding) the threshold capacitance, or (ii) a second control signal to allow the valve 220 to be closed based upon the first capacitance meeting (e.g., exceeding) the threshold capacitance.

As shown in FIG. 3B, upon charging the first capacitor 102, a first electric field 352 may be established between the first plurality of positive charges 354 and the first plurality of negative charges 356. An intensity of the first electric field 352 and capacitance of the first capacitor 102 may change based upon changes in proportional composition of components in the first mixture and/or changes in dielectric properties of the first mixture over time.

In some examples, a second process of measuring associated with a second capacitance of the first capacitor 102 may be started after the fourth period of time T₄ in the second measurement period 301b. In some examples, operations carried out in the second stage 350 and/or in the third stage 390 may similarly be repeated in the second process in the second measurement period 301b. In some examples, processes of measuring capacitance of the first capacitor 102 may be iteratively executed until a measured capacitance of the first capacitor 102 meets (e.g., exceeds) the threshold capacitance.

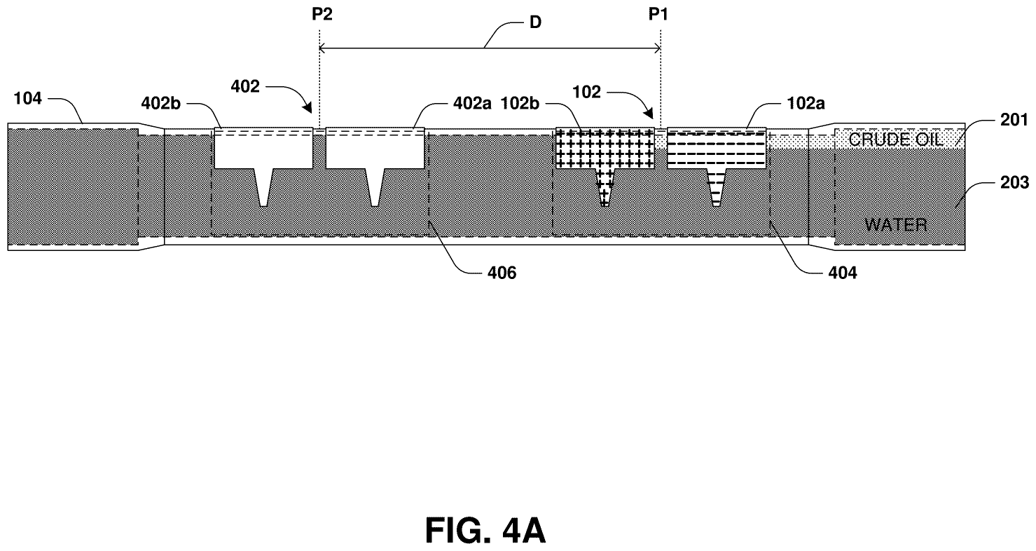

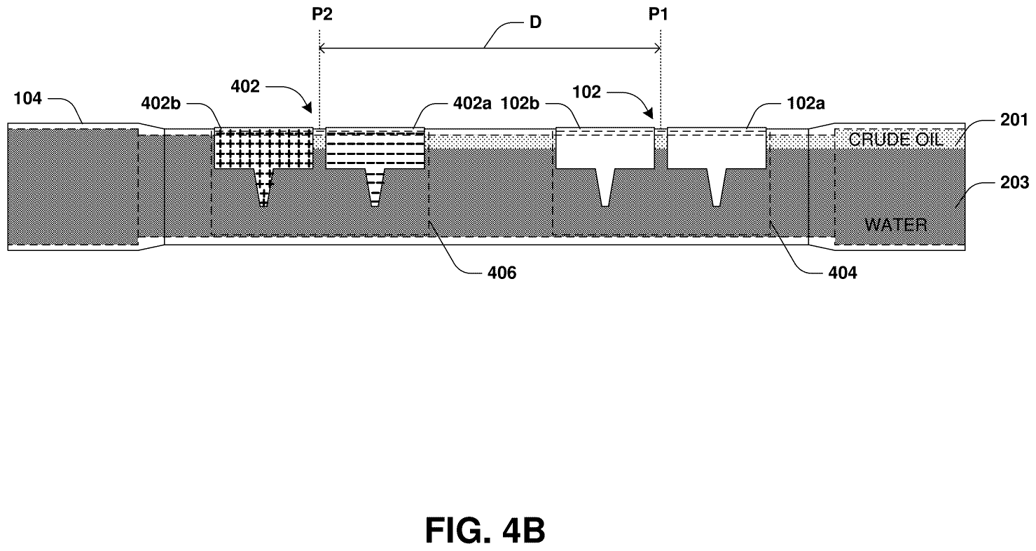

In some examples, the third capacitor C3 and/or the fourth capacitor C4 may provide current stabilization for the mixture evaluation device 112 in the second period of time T₂ and/or in the fourth period of time T₄ after the third period of time T₃. In some examples, the operational amplifier 307 may provide voltage buffering for the mixture evaluation device 112 during charging and discharging the first capacitor 102 and the second capacitor 302. In some examples, the one or more Analog-to-Digital convertors may convert one or more analog signals (e.g., an output signal Vout of the operational amplifier 307 of the switch capacitor 309) to one or more digital signals. For clarity, FIGS. 3A-4C illustrate a simplified view that shows the non-conductive pipe 104 without showing other components of the conduit 101, the mixture evaluation device 112 and/or the power source 204.

FIGS. 4A-4B illustrate two stages of measuring flow rate of the first mixture using the apparatus 100, in accordance with some embodiments. In some examples, the apparatus 100 may comprise a third electrode 402a and/or a fourth electrode 402b. In some examples, the third electrode 402a may be placed (e.g., embedded) proximal (e.g., adjacent to and/or within a threshold distance of the flow path 103, such as 0.5 centimeter or 5 centimeters) the flow path 103 defined by the conduit 101. In some examples, the fourth electrode 402b may be placed (e.g., embedded) proximal (e.g., adjacent to and/or within the threshold distance of the flow path 103, such as 0.5 centimeter or 5 centimeters) the flow path 103 defined by the conduit 101. In some examples, the power source 204 may apply (e.g., provide) the first voltage across the first electrode 102a and the second electrode 102b. In some examples, the power source 204 may apply (e.g., provide) a third voltage (e.g., the first voltage) across the third electrode 402a and the fourth electrode 402b.

In some examples, the mixture evaluation device 112 may be configured to determine a first set of capacitances (e.g., a first set of one or more capacitances) of the first capacitor 102 established by the first electrode 102a, the second electrode 102b, and the first mixture flowing along the flow path 103, wherein the first set of capacitances may comprise one or more capacitances of the first capacitor 102 at one or more first times. In some examples, the one or more first times may be during the one or more measurement periods. In some examples, each capacitance of the first set of capacitances may be associated with a time of the one or more first times. For example, a first capacitance (e.g., about 0.12 picofarads which may indicate 100% water and/or 0% crude oil in the first mixture) of the first set of capacitances corresponds to a capacitance of the first capacitor 102 at a first time (e.g., about 186 microseconds or less than 186 microseconds which is during the first measurement period 301a) of the one or more first times. A second capacitance (e.g., about 0.66 picofarads) of the first set of capacitances corresponds to a capacitance of the first capacitor 102 at a second time (e.g., about 372 microseconds or less than 372 microseconds which is during a second measurement period 301b) of the one or more first times.

In some examples, the mixture evaluation device 112 may be configured to determine a second set of capacitances (e.g., a second set of one or more capacitances) of a third capacitor 402 established by the third electrode 402a, the fourth electrode 402b, and the first mixture flowing along the flow path 103, wherein the second set of capacitances may comprise one or more capacitances of the third capacitor 402 at one or more second times. In some examples, the one or more second times may be during the one or more measurement periods. In some examples, each capacitance of the second set of capacitances may be associated with a time of the one or more second times. For example, a third capacitance (e.g., about 0.12 picofarads which may indicate 100% water and/or 0% crude oil in the first mixture) of the second set of capacitances corresponds to a capacitance of the third capacitor 402 at a third time (e.g., about 186 microseconds or less than 186 microseconds which is during the first measurement period 301a) of the one or more second times. A fourth capacitance (e.g., about 0.66 picofarads) of the first set of capacitances corresponds to a capacitance of the first capacitor 102 at a fourth time (e.g., about 2790 microseconds or less than 2790 microseconds which is during a fifteenth measurement period) of the one or more first times. In some examples, when electrodes of the third capacitor 402 match electrodes of the first capacitor 102, the first set of capacitances and the second set of capacitances may be analyzed to identify matching capacitances among the first set of capacitances and the second set of capacitances, to determine one or more time differences between the matching capacitances, and determine a flow rate of the first mixture flowing through the flow path 103 based upon the one or more time differences. For example, in response to determining that the fourth capacitance (e.g., about 0.66 picofarads) associated with the fourth time (e.g., about 2790 microseconds) matches the second capacitance (e.g., about 0.66 picofarads) associated with the second time (e.g., about 372 microseconds), a time difference between the fourth time and the second time may be determined, and/or a flow rate (e.g., a volumetric flow rate) of the first mixture flowing through the flow path 103 may be determined based upon the time difference. For example, the flow rate may be determined to be about 296 liters per second based upon the time difference being about 2418 microseconds.

In some examples, the mixture evaluation device 112 may be configured to determine a volumetric flow rate of the first mixture based upon the time difference between the second time at which a second capacitance (e.g., about 0.66 picofarads which may indicate 90% water and/or 10% crude oil) of the first mixture is determined at a first location P1 and a fourth time at which the fourth capacitance (e.g., about 0.66 picofarads) of the first mixture is detected at a second location P2 downstream. The volumetric flow rate may be calculated by dividing a distance D (e.g., about 150 millimeters) between the first location P1 and the second location P2 by the time difference (e.g., 2418 microseconds). In some examples, the flow rate may be calculated by dividing the distance D by the time difference (e.g., 2418 microseconds). For example, the flow rate may be determined to be about 62 meters per second based upon the time difference being about 2418 microseconds.

In some examples, the mixture evaluation device 112 may be configured to determine a second flow rate of the first mixture flowing through the flow path 103 based upon the first set of capacitances and the second set of capacitances. In some examples, the mixture evaluation device 112 may be configured to determine, based upon the first set of capacitances, a fifth time at which a portion (e.g., 80% water and/or 20% crude oil) of the first mixture flows through a first portion 404, of the flow path 103, proximal at least one of the first electrode 102a or the second electrode 102b. In some examples, the mixture evaluation device 112 may be configured to determine, based upon the second set of capacitances, a sixth time at which the portion (e.g., 80% water and/or 20% crude oil) of the first mixture flows through a second portion 406, of the flow path 103, proximal at least one of the third electrode 402a or the fourth electrode 402b. In some examples, the mixture evaluation device 112 may be configured to determine the second flow rate of the first mixture based upon the fifth time and the sixth time. In some examples, the mixture evaluation device 112 may be configured to determine the second flow rate of the first mixture based upon a second time difference (e.g., delay) between the fifth time and the sixth time.

In some examples, the mixture evaluation device 112 may be configured to compare the first set of capacitances with the second set of capacitances to identify a fifth capacitance, from the first set of capacitances, that matches a sixth capacitance from the second set of capacitances. In some examples, the fifth capacitance may be determined to match the sixth capacitance based upon a determination that (i) the fifth capacitance is about equal to the sixth capacitance, and/or (ii) a difference between the fifth capacitance and the sixth capacitance is less than a threshold difference. In some examples, the mixture evaluation device 112 may be configured to determine the second flow rate of the first mixture based upon the fifth time associated with the fifth capacitance and the sixth time associated with the sixth capacitance.

In some examples, the mixture evaluation device 112 may be configured to determine a first set of composition properties associated with the first mixture based upon the first set of capacitances. In some examples, the first set of composition properties may comprise one or more first composition properties of the first mixture flowing through the first portion 404 of the flow path 103 at the one or more first times, wherein the first portion 404 of the flow path 103 may be proximal at least one of the first electrode 102a or the second electrode 102b.

In some examples, a second set of composition properties may comprise one or more second composition properties of the first mixture flowing through the second portion 406 of the flow path in the one or more second times, wherein the second portion 406 of the flow path 103 may be proximal at least one of the third electrode 402a or the fourth electrode 402b.

In some examples, the mixture evaluation device 112 may be configured to determine a third flow rate of the first mixture flowing through the flow path 103 based upon the first set of composition properties and the second set of composition properties.

In some examples, the mixture evaluation device 112 may be configured to compare the first set of composition properties with the second set of composition properties to identify a third composition property from the first set of composition properties, that matches a fourth composition property from the second set of composition properties.

In some examples, the mixture evaluation device 112 may be configured to determine the third flow rate of the first mixture based upon a seventh time associated with the third composition property and an eighth time associated with the fourth composition property.

In some examples, the mixture evaluation device 112 may be configured to compare the first set of capacitances with the second set of capacitances to identify a seventh capacitance from the first set of capacitances, that matches an eighth capacitance from the second set of capacitances.

In some examples, the mixture evaluation device 112 may be configured to determine the third flow rate of the first mixture based upon the seventh time associated with the seventh capacitance and the eighth time associated with the eighth capacitance. For clarity, FIGS. 4A-4B illustrate a simplified view that shows the non-conductive pipe 104 without showing other components of the conduit 101, the mixture evaluation device 112 and/or the power source 204.

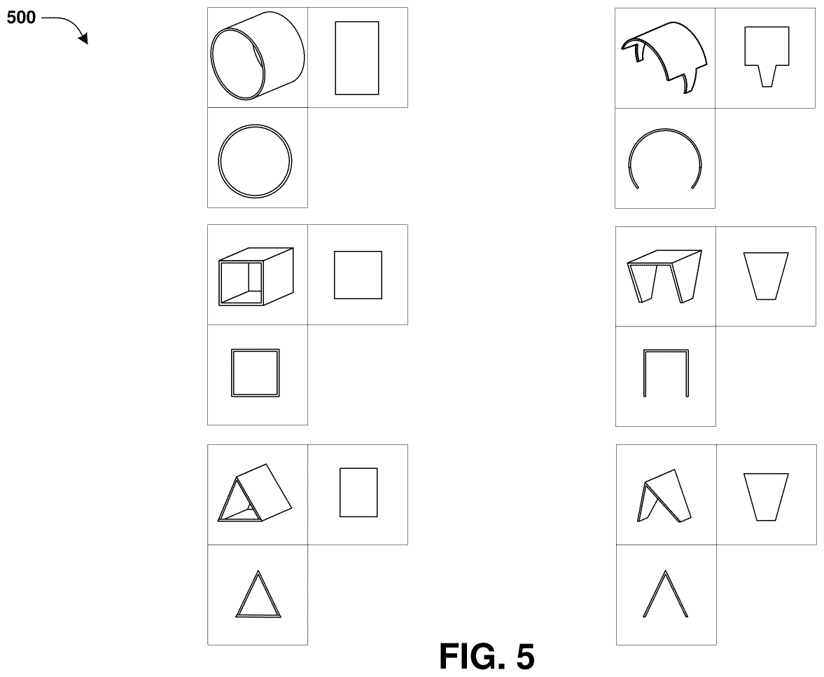

FIG. 5 illustrates an image 500 of a plurality of shapes associated with capacitor electrodes designed for placement on a plurality of non-conductive pipes with different geometries, in accordance with some embodiments. The capacitor electrodes may be shaped or patterned to conform to outer surface profile of the plurality of non-conductive pipes (e.g., non-conductive pipes with circular, oval, rectangular, or irregular cross-sections) to ensure optimal capacitive coupling. In some examples, the capacitor electrodes may be formed using conductive inks, foils, or films, and adhered or printed onto the outer surface of the non-conductive pipes to facilitate capacitive sensing, flow detection, or material characterization.

In some examples, the apparatus 100 comprises a display that displays information such as a measured flow rate of the first mixture, an indication of a determined composition property of the first mixture, and/or other information determined by the apparatus 100 in accordance with the present disclosure.

In some examples, an apparatus is provided. The apparatus includes a conduit configured to conduct a mixture along a flow path, a first electrode proximal the flow path defined by the conduit, a second electrode proximal the flow path defined by the conduit, a power source configured to apply a voltage across the first electrode and the second electrode, and a mixture evaluation device. The mixture evaluation device is configured to: (i) determine a first capacitance of a first capacitor established by the first electrode, the second electrode, and the mixture flowing along the flow path, and (ii) determine a composition property of the mixture based upon the first capacitance.

In some examples, the first capacitor includes an in-situ dielectric capacitor having a capacitance that varies based upon a dielectric property of the mixture.

In some examples, the mixture evaluation device includes a second capacitor electrically connected to the first capacitor.

In some examples, the mixture evaluation device is configured to: (i) charge the first capacitor using the power source during a first period of time (ii) electrically disconnect the power source from the first capacitor during a second period of time after the first period of time (iii) transfer charge from the first capacitor to the second capacitor during a third period of time after the second period of time, and (iv) measure one or more electrical parameters of the second capacitor, wherein the first capacitance of the first capacitor is determined based upon the one or more electrical parameters.

In some examples, the mixture evaluation device includes one or more analog switches, one or more capacitors, one or more operational amplifiers and/or one or more Analog-to-Digital convertors. The one or more analog switches are configured to receive a first pulse to: (i) apply an electric connection between the power source and the first capacitor, and (ii) allow the power source to charge the first capacitor in the first period of time. The one or more analog switches are configured to receive a second pulse to: (i) apply an electric disconnection between the power source and the first capacitor in the second period of time after the first period of time, and (ii) apply an electric connection between the first capacitor and the second capacitor for charging the second capacitor in the third period of time after the second period of time. The one or more capacitors are configured to provide current stabilization for the mixture evaluation device in the second period of time and a fourth period of time after the third period of time. The one or more operational amplifiers are configured to provide voltage buffering for the mixture evaluation device during charging and discharging the first capacitor and the second capacitor. The one or more Analog-to-Digital convertors are configured to convert one or more analog signals to one or more digital signals. The first pulse is a first periodic pulse. The second pulse is a second periodic pulse. The first periodic pulse and the second periodic pulse are Non-overlapping pulse.

In some examples, the composition property is indicative of a measure of one or more first substances in the mixture.

In some examples, the apparatus includes a valve coupled to the conduit and configured to control flow of the mixture through the flow path defined by the conduit, wherein the mixture evaluation device is configured to: (i) compare the composition property of the mixture with a threshold composition property, and (ii) control the valve based upon the comparison.

In some examples, the mixture evaluation device is configured to open the valve in response to the composition property of the mixture not meeting the threshold composition property.

In some examples, the mixture evaluation device is configured to close the valve in response to the composition property of the mixture meeting the threshold composition property.

In some examples, the apparatus includes a protective enclosure configured to house the mixture evaluation device.

In some examples, the protective enclosure includes a user-operated switch configured to control a state of the valve.

In some examples, the valve is configured to open and/or close the flow path in response to detecting a false condition. The false condition includes: (i) an interruption associated with the power source, (ii) a short circuit associated with the power source, or (iii) a failure associated with the mixture evaluation device.

In some examples, the conduit includes a first flange, a second flange, a non-conductive pipe, a first connecting pipe, a first hollow annular disk, a second connecting pipe, a second hollow annular disk, a discharge pipe and/or a conductive pipe. The first flange is connected to the first connecting pipe. The second flange is connected to the second connecting pipe from one side and the discharge pipe from the other side. The non-conductive pipe is configured to house a portion of the first connecting pipe and a portion of the second connecting pipe. The first hollow annular disk includes a first central aperture configured to house a portion of the first connecting pipe. The second hollow annular disk includes a second central aperture configured to house a portion of the second connecting pipe. The conductive pipe is connected to the first hollow annular disk and the second hollow annular disk. The conductive pipe is configured to house the first electrode, the second electrode, a portion of a first connecting wire connecting the first electrode to the mixture evaluation device, a portion of a second connecting wire connecting the second electrode to the mixture evaluation device, the non-conductive pipe, an epoxy resin filled in a space between the non-conductive pipe and the conductive pipe, the portion of the first connecting pipe, and/or the portion of the second connecting pipe.

In some examples, an apparatus is provided. The apparatus includes a conduit, a first electrode, a second electrode, a third electrode, a fourth electrode, a power source and a mixture evaluation device. The conduit is configured to conduct a mixture along a flow path. The first electrode is placed proximal the flow path defined by the conduit. The second electrode is placed proximal the flow path defined by the conduit. The third electrode is placed proximal the flow path defined by the conduit. The fourth electrode is placed proximal the flow path defined by the conduit. The power source is configured to apply: (i) a first voltage across the first electrode and the second electrode, and (ii) a second voltage across the third electrode and the fourth electrode. The mixture evaluation device is configured to: (i) determine a first set of capacitances of a first capacitor established by the first electrode, the second electrode, and the mixture flowing along the flow path, wherein the first set of capacitances comprises one or more capacitances of the first capacitor at one or more first times, (ii) determine a second set of capacitances of a second capacitor established by the third electrode, the fourth electrode, and the mixture flowing along the flow path, wherein the second set of capacitances comprises one or more capacitances of the second capacitor at one or more second times, and (iii) determine a flow rate of the mixture flowing through the flow path based upon the first set of capacitances and the second set of capacitances.

In some examples, the mixture evaluation device is configured to: (i) determine, based upon the first set of capacitances, a first time at which a portion of the mixture flows through a first portion, of the flow path, proximal at least one of the first electrode or the second electrode, (ii) determine, based upon the second set of capacitances, a second time at which the portion of the mixture flows through a second portion, of the flow path, proximal at least one of the third electrode or the fourth electrode, and determine the flow rate of the mixture based upon the first time and the second time.

In some examples, the mixture evaluation device is configured to: (i) compare the first set of capacitances with the second set of capacitances to identify a first capacitance, from the first set of capacitances, that matches a second capacitance from the second set of capacitances, and (ii) determine the flow rate of the mixture based upon a first time associated with the first capacitance and a second time associated with the second capacitance.

In some examples, the mixture evaluation device is configured to: (i) determine, based upon the first set of capacitances, a first set of composition properties associated with the mixture, and (ii) determine the flow rate of the mixture flowing through the flow path based upon the first set of composition properties and the second set of composition properties. The first set of composition properties includes one or more composition properties of the mixture flowing through a first portion of the flow path at the one or more first times, wherein the first portion of the flow path is proximal at least one of the first electrode or the second electrode. A second set of composition properties includes one or more composition properties of the mixture flowing through a second portion of the flow path at the one or more second times, wherein the second portion of the flow path is proximal at least one of the third electrode or the fourth electrode.

In some examples, the mixture evaluation device is configured to: (i) compare the first set of composition properties with the second set of composition properties to identify a first composition property from the first set of composition properties, that matches a second composition property from the second set of composition properties, (ii) determine the flow rate of the mixture based upon a first time associated with the first composition property and a second time associated with the second composition property, (iii) compare the first set of capacitances with the second set of capacitances to identify a first capacitance, from the first set of capacitances, that matches a second capacitance from the second set of capacitances, and (iv) determine the flow rate of the mixture based upon a first time associated with the first capacitance and a second time associated with the second capacitance.

In some examples, an apparatus is provided. The apparatus includes a conduit, a first electrode, a second electrode, a power source, a valve and a controller. The conduit is configured to conduct a mixture along a flow path. The first electrode is placed proximal the flow path defined by the conduit. The second electrode is placed proximal the flow path defined by the conduit. The power source is configured to apply a voltage across the first electrode and the second electrode. The valve is coupled to the conduit and is configured to control flow of the mixture through the flow path defined by the conduit. The controller is configured to: (i) determine a first capacitance of a first capacitor established by the first electrode, the second electrode, and the mixture flowing along the flow path, and control the valve based upon the first capacitance.

In some examples, the controller is configured to determine a composition property of the mixture based upon the first capacitance.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments and/or examples are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment and/or example provided herein. Also, it will be understood that not all operations are necessary in some embodiments and/or examples.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An apparatus, comprising:
a conduit configured to conduct a mixture along a flow path;
a first electrode proximal the flow path defined by the conduit;
a second electrode proximal the flow path defined by the conduit;
a power source configured to apply a voltage across the first electrode and the second electrode; and
a mixture evaluation device configured to:
determine a first capacitance of a first capacitor established by the first electrode, the second electrode, and the mixture flowing along the flow path; and
determine a composition property of the mixture based upon the first capacitance.

2. The apparatus of claim 1, wherein the first capacitor comprises:
an in-situ dielectric capacitor having a capacitance that varies based upon a dielectric property of the mixture.

3. The apparatus of claim 1, wherein the mixture evaluation device comprises:
a second capacitor electrically connected to the first capacitor.

4. The apparatus of claim 3, wherein the mixture evaluation device is configured to:
charge the first capacitor using the power source during a first period of time;
electrically disconnect the power source from the first capacitor during a second period of time after the first period of time;
transfer charge from the first capacitor to the second capacitor during a third period of time after the second period of time; and
measure one or more electrical parameters of the second capacitor, wherein the first capacitance of the first capacitor is determined based upon the one or more electrical parameters.

5. The apparatus of claim 4, wherein:
the mixture evaluation device comprises at least one of:
one or more analog switches configured to:
receive a first pulse to: (i) apply an electric connection between the power source and the first capacitor, and (ii) allow the power source to charge the first capacitor in the first period of time; and
receive a second pulse to: (i) apply an electric disconnection between the power source and the first capacitor in the second period of time after the first period of time, and (ii) apply an electric connection between the first capacitor and the second capacitor for charging the second capacitor in the third period of time after the second period of time;
one or more capacitors configured to provide current stabilization for the mixture evaluation device in the second period of time and a fourth period of time after the third period of time;
one or more operational amplifiers configured to provide voltage buffering for the mixture evaluation device during charging and discharging the first capacitor and the second capacitor; or
one or more Analog-to-Digital convertors configured to convert one or more analog signals to one or more digital signals;
the first pulse is a first periodic pulse;
the second pulse is a second periodic pulse; and
the first periodic pulse and the second periodic pulse are Non-overlapping pulse.

6. The apparatus of claim 1, wherein:
the composition property is indicative of a measure of one or more first substances in the mixture.

7. The apparatus of claim 1, comprising:
a valve coupled to the conduit and configured to control flow of the mixture through the flow path defined by the conduit, wherein the mixture evaluation device is configured to:
compare the composition property of the mixture with a threshold composition property; and
control the valve based upon the comparison.

8. The apparatus of claim 7, wherein the mixture evaluation device is configured to:
open the valve in response to the composition property of the mixture not meeting the threshold composition property.

9. The apparatus of claim 7, wherein the mixture evaluation device is configured to:
close the valve in response to the composition property of the mixture meeting the threshold composition property.

10. The apparatus of claim 7, comprising:
a protective enclosure configured to house the mixture evaluation device.

11. The apparatus of claim 10, wherein the protective enclosure comprises a user-operated switch configured to control a state of the valve.

12. The apparatus of claim 7, wherein:
the valve is configured to at least one of open or close the flow path in response to detecting a false condition; and
the false condition comprises at least one of:
an interruption associated with the power source;
a short circuit associated with the power source; or
a failure associated with the mixture evaluation device.

13. The apparatus of claim 1, wherein the conduit comprises at least one of:
a first flange connected to a first connecting pipe;
a second flange connected to a second connecting pipe from one side and a discharge pipe from the other side;
a non-conductive pipe configured to house a portion of the first connecting pipe and a portion of the second connecting pipe;
the first connecting pipe;
a first hollow annular disk having a first central aperture configured to house a portion of the first connecting pipe;
the second connecting pipe;
a second hollow annular disk having a second central aperture configured to house a portion of the second connecting pipe;
the discharge pipe; or
a conductive pipe connected to the first hollow annular disk and the second hollow annular disk, wherein the conductive pipe is configured to house at least one of:
the first electrode;
the second electrode;
a portion of a first connecting wire connecting the first electrode to the mixture evaluation device;
a portion of a second connecting wire connecting the second electrode to the mixture evaluation device;
the non-conductive pipe;
an epoxy resin filled in a space between the non-conductive pipe and the conductive pipe;
the portion of the first connecting pipe; or
the portion of the second connecting pipe.

14. An apparatus, comprising:
a conduit configured to conduct a mixture along a flow path;
a first electrode proximal the flow path defined by the conduit;
a second electrode proximal the flow path defined by the conduit;
a third electrode proximal the flow path defined by the conduit;
a fourth electrode proximal the flow path defined by the conduit;
a power source configured to apply:
a first voltage across the first electrode and the second electrode; and
a second voltage across the third electrode and the fourth electrode; and
a mixture evaluation device configured to:
determine a first set of capacitances of a first capacitor established by the first electrode, the second electrode, and the mixture flowing along the flow path, wherein the first set of capacitances comprises one or more capacitances of the first capacitor at one or more first times;
determine a second set of capacitances of a second capacitor established by the third electrode, the fourth electrode, and the mixture flowing along the flow path, wherein the second set of capacitances comprises one or more capacitances of the second capacitor at one or more second times; and
determine a flow rate of the mixture flowing through the flow path based upon the first set of capacitances and the second set of capacitances.

15. The apparatus of claim 14, wherein the mixture evaluation device is configured to:
determine, based upon the first set of capacitances, a first time at which a portion of the mixture flows through a first portion, of the flow path, proximal at least one of the first electrode or the second electrode;
determine, based upon the second set of capacitances, a second time at which the portion of the mixture flows through a second portion, of the flow path, proximal at least one of the third electrode or the fourth electrode; and
determine the flow rate of the mixture based upon the first time and the second time.

16. The apparatus of claim 14, wherein the mixture evaluation device is configured to:
compare the first set of capacitances with the second set of capacitances to identify a first capacitance, from the first set of capacitances, that matches a second capacitance from the second set of capacitances; and
determine the flow rate of the mixture based upon a first time associated with the first capacitance and a second time associated with the second capacitance.

17. The apparatus of claim 14, wherein the mixture evaluation device is configured to:
determine, based upon the first set of capacitances, a first set of composition properties associated with the mixture, wherein:
the first set of composition properties comprises one or more composition properties of the mixture flowing through a first portion of the flow path at the one or more first times, wherein the first portion of the flow path is proximal at least one of the first electrode or the second electrode; and
a second set of composition properties comprises one or more composition properties of the mixture flowing through a second portion of the flow path at the one or more second times, wherein the second portion of the flow path is proximal at least one of the third electrode or the fourth electrode; and
determine the flow rate of the mixture flowing through the flow path based upon the first set of composition properties and the second set of composition properties.

18. The apparatus of claim 17, wherein the mixture evaluation device is configured to:
compare the first set of composition properties with the second set of composition properties to identify a first composition property from the first set of composition properties, that matches a second composition property from the second set of composition properties;
determine the flow rate of the mixture based upon a first time associated with the first composition property and a second time associated with the second composition property;
compare the first set of capacitances with the second set of capacitances to identify a first capacitance, from the first set of capacitances, that matches a second capacitance from the second set of capacitances; and
determine the flow rate of the mixture based upon a first time associated with the first capacitance and a second time associated with the second capacitance.

19. An apparatus, comprising:
a conduit configured to conduct a mixture along a flow path;
a first electrode proximal the flow path defined by the conduit;
a second electrode proximal the flow path defined by the conduit;
a power source configured to apply a voltage across the first electrode and the second electrode;
a valve coupled to the conduit and configured to control flow of the mixture through the flow path defined by the conduit; and
a controller configured to:
determine a first capacitance of a first capacitor established by the first electrode, the second electrode, and the mixture flowing along the flow path; and
control the valve based upon the first capacitance.

20. The apparatus of claim 19, wherein the controller is configured to:
determine a composition property of the mixture based upon the first capacitance.
